(19) United States
(12) Patent Application Publication
(10) Pub. No.: US 2025/0188259 A1
(43) Pub. Date: Jun. 12, 2025

(54) COMPOSITION, INJECTION MOLDED ARTICLE, POWDER COATING AND COATED WIRE

(71) Applicant: DAIKIN INDUSTRIES, LTD., Osaka (JP)

(72) Inventors: Tadaharu ISAKA, Osaka (JP); Hayato TSUDA, Osaka (JP); Yukari YAMAMOTO, Osaka (JP); Yumi ZENKE, Osaka (JP)

(73) Assignee: DAIKIN INDUSTRIES, LTD., Osaka (JP)

(21) Appl. No.: 19/058,232

(22) Filed: Feb. 20, 2025

Related U.S. Application Data
(63) Continuation of application No. PCT/JP2023/025952, filed on Jul. 13, 2023.

(30) Foreign Application Priority Data
Aug. 26, 2022 (JP) 2022-134930

(51) Int. Cl. C08L 27/18; C09D 5/03; C09D 127/18; H01B 3/44

(52) U.S. Cl. CPC C08L 27/18; C09D 5/03; C09D 127/18; H01B 3/445; C08L 2203/202; C08L 2205/025

(57) ABSTRACT

There is provided a composition comprising a composition comprising a polytetrafluoroethylene and a fluorine-containing copolymer, wherein a content of the polytetrafluoroethylene in the composition is 0.03 to 0.30% by mass with respect to the mass of the composition; the fluorine-containing copolymer comprises tetrafluoroethylene unit, hexafluoropropylene unit and perfluoro(propyl vinyl ether) unit; a content of hexafluoropropylene unit in the fluorine-containing copolymer is 8.5 to 11.2% by mass with respect to the whole of the monomer units; a content of perfluoro(propyl vinyl ether) unit in the fluorine-containing copolymer is 0.5 to 2.0% by mass with respect to the whole of the monomer units; and a melt flow rate at 372° C. of the fluorine-containing copolymer is 13.0 to 42.0 g/10 min.

### CROSS-REFERENCE TO RELATED APPLICATIONS

This application is a Rule 53(b) Continuation of International Application No. PCT/JP2023/025952 filed Jul. 13, 2023, which claims priority based on Japanese Patent Application No. 2022-134930 filed Aug. 26, 2022, the respective disclosures of which are incorporated herein by reference in their entirety.

### TECHNICAL FIELD

The present disclosure relates to a composition, an injection molded article, a powder coating material, and a coated electric wire.

### BACKGROUND ART

Patent Literature 1 describes a fluororesin composition which contains a polytetrafluoroethylene [PTFE] having a standard specific gravity of 2.15 to 2.30 and a tetrafluoroethylene/hexafluoropropylene-based copolymer [FEP] wherein the content of the PTFE is 0.01 to 3 parts by mass with respect to 100 parts by mass of the FEP, and the content of an alkali metal is lower than 5 ppm with respect to the solid content of the resin composition, and which is obtained by a method having a step (1) of mixing an aqueous dispersion containing the FEP with an aqueous dispersion containing the PTFE, and coagulating the resultant, to thereby obtain a cocoagulated powder of the fluororesins, a step (2) of melt extruding the cocoagulated powder, and a step (3) of subjecting unstable terminal groups of the PTFE and the FEP to a stabilization treatment.

Patent Literature 2 describes a fluororesin composition which is composed of 100 parts by mass of a tetrafluoroethylene/hexafluoropropylene-based copolymer, and 0.01 to 3 parts by mass of a polytetrafluoroethylene having a standard specific gravity of 2.15 to 2.30, and is obtained by mixing an aqueous dispersion composed of the tetrafluoroethylene/hexafluoropropylene-based copolymer with an aqueous dispersion composed of the polytetrafluoroethylene, thereafter coagulating, then drying and thereafter melt extruding the resultant.

### RELATED ART

### Patent Literature

Patent Literature 1: International Publication No. WO 2009/044753
Patent Literature 2: International Publication No. WO 2006/123694

### SUMMARY

According to the present disclosure, there is provided a composition comprising a polytetrafluoroethylene and a fluorine-containing copolymer, wherein a content of the polytetrafluoroethylene in the composition is 0.03 to 0.30% by mass with respect to the mass of the composition; the fluorine-containing copolymer comprises tetrafluoroethylene unit, hexafluoropropylene unit and perfluoro(propyl vinyl ether) unit; a content of hexafluoropropylene unit in the fluorine-containing copolymer is 8.5 to 11.2% by mass with respect to the whole of the monomer units; and a content of perfluoro(propyl vinyl ether) unit in the fluorine-containing copolymer is 0.5 to 2.0% by mass with respect to the whole of the monomer units; and a melt flow rate at 372° C. of the fluorine-containing copolymer is 13.0 to 42.0 g/10 min.

### Effects

According to the present disclosure, there can be provided a composition which is excellent in the injection moldability, the coating film formability and the electric wire coating formability, and can give a formed article excellent in the deformation resistance to high temperatures and high loads, the stress crack resistance, the deformation resistance to tensile stress, and the durability to repeated stress loads.

### DESCRIPTION OF EMBODIMENTS

Hereinafter, specific embodiments of the present disclosure will be described in detail, but the present disclosure is not limited to the following embodiments.

A composition of the present disclosure comprises a polytetrafluoroethylene and a fluorine-containing copolymer.

In Patent Literature 1, with an object to provide a fluororesin composition which hardly causes forming defects even when being formed at a high speed in a coating extrusion forming in a relatively broad temperature range, and can give an electric wire excellent in the surface smoothness, particularly a foamed electric wire, the above-mentioned fluororesin composition is proposed. Then, in Patent Literature 2, aiming at improving the formability in melt extrusion forming, the above-mentioned fluororesin composition is proposed.

However, on means of improving the injection moldability of the fluorine-containing copolymer containing tetrafluoroethylene unit, hexafluoropropylene unit and perfluoro(propyl vinyl ether) unit, no studies at all are made. Also on improving physical properties of the injection molded article, no studies at all are made.

In consideration of such a real situation, the present disclosure has an object to provide a composition which can improve the injection moldability of a fluorine-containing copolymer comprising tetrafluoroethylene unit, hexafluoropropylene unit and perfluoro(propyl vinyl ether) unit, and can give a formed article excellent in the deformation resistance to high temperatures and high loads. Then, the composition of the present disclosure is excellent in the coating film formability and the electric wire coating formability. Further, use of the composition of the present disclosure can give a formed article excellent in the stress crack resistance, the deformation resistance to tensile stress, and the durability to repeated stress loads.

### (Polytetrafluoroethylene)

The composition of the present disclosure comprises a polytetrafluoroethylene (PTFE). Since the composition of the present disclosure contains the PTFE in a limited amount, and as described later, the composition contains the fluorine-containing copolymer whose composition and melt flow are limited, the composition can easily be molded by injection molding, and further can give an injection molded article excellent in beauty and excellent also in the deformation resistance to high temperatures and high loads. Then, the composition of the present disclosure is excellent also in the coating film formability and the electric wire coating formability. Further, use of the composition of the present disclosure can give a formed article excellent in the stress crack resistance, the deformation resistance to tensile stress, and the durability to repeated stress loads.

The PTFE contained in the composition of the present disclosure may be a non melt-processible PTFE, or may be a melt-processible PTFE. The PTFE is preferably a non melt-processible PTFE, because the injection moldability of the composition and the deformation resistance of injection molded articles are more improved and the coating film formability and the electric wire coating formability, and also the stress crack resistance, the deformation resistance to tensile stress and the durability to repeated stress loads of formed articles are improved.

The non-melt-processibility means a property in which the melt flow rate cannot be measured at a temperature higher than the melting point of the PTFE and according to ASTM D1238 and D2116.

The PTFE may be a fibrillatable PTFE, or may be a non-fibrillatable PTFE. The PTFE is preferably a fibrillatable PTFE, because the injection moldability of the composition and the deformation resistance of injection molded articles are more improved and the coating film formability and the electric wire coating formability, and also the stress crack resistance, the deformation resistance to tensile stress and the durability to repeated stress loads of formed articles are improved.

Whether having the fibrillatability or not can be judged by the “paste extrusion”, which is a typical method of forming a “high molecular weight PTFE powder” being a powder made from a polymer of TFE. Usually, that the paste extrusion is possible is due to that the high molecular weight PTFE is fabrillatable. In the case where an unsintered formed article obtained by the paste extrusion has substantially no strength and elongation, for example, in the case where the formed article is broken at an elongation of 0% on being pulled, the formed article can be regarded as having no fibrillatability.

The standard specific gravity (SSG) of the PTFE is preferably 2.15 to 2.25, and more preferably 2.20 or lower. By making the standard specific gravity to be in the above range, the injection moldability of the composition and the deformation resistance of injection molded articles are more improved and the coating film formability and the electric wire coating formability, and also the stress crack resistance, the deformation resistance to tensile stress and the durability to repeated stress loads of formed articles can be improved.

The standard specific gravity can be measured by using a sample formed according to ASTM D4895-89 and by a water displacement method according to ASTM D792.

The melting point of the PTFE is preferably 320° C. or higher, more preferably 323° C. or higher and still more preferably 325° C. or higher, and preferably 337° C. or lower, more preferably 335° C. or lower and still more preferably 333° C. or lower.

The melting point (secondary melting point) of the PTFE can be specified as a temperature corresponding to the peak top in a melt curve peak in differential scanning calorimetry by using a differential scanning calorimeter and heating, as first time temperature raising, a measuring object at a temperature-increasing rate of 10° C./min from 230° C. to 380° C. and then cooling at a cooling rate of 10° C./min from 380° C. to 230° C., and again heating, as second time temperature raising, at a temperature-increasing rate of 10° C./min from 230° C. to 380° C. and recording the melt curve peak generated in the second time temperature raising course.

The PTFE may be a TFE homopolymer containing TFE unit alone, or may be a modified PTFE containing TFE unit and a modifying monomer unit copolymerizable with TFE.

Examples of the modifying monomer include perfluoroolefins such as hexafluoropropylene; chlorofluoroolefins such as chlorotrifluoroethylene; hydrogen-containing fluoroolefins such as trifluoroethylene and vinylidene fluoride; fluoroalkyl vinyl ethers; fluoroalkyl allyl ethers; perfluoroalkylethylenes; and ethylene.

The content of the modifying monomer unit in the PTFE is, with respect to the whole of the monomer units constituting the PTFE, preferably 0 to 1.0% by mass, and more preferably 0.5% by mass or lower, still more preferably 0.2% by mass or lower and especially preferably 0.1% by mass or lower.

The content of TFE unit in the PTFE is, with respect to the whole of the monomer units constituting the PTFE, preferably 100 to 99.0% by mass, and more preferably 99.5% by mass or higher, still more preferably 99.8% by mass or higher and especially preferably 99.9% by mass or higher.

The content of each monomer constituting the PTFE can be calculated by suitably combining, depending on the kind of the monomers, NMR, FT-IR, elemental analysis, and X-ray fluorescence analysis.

A PTFE to be used for obtaining the composition by mixing the PTFE and the fluorine-containing copolymer may be a PTFE dispersed in an aqueous medium, or may be a PTFE powder. The PTFE powder may be a PTFE fine powder, or may be a PTFE molding powder.

In one embodiment, primary particles of the PTFE dispersed in an aqueous medium can be used. The average primary particle diameter of the PTFE is preferably 10 to 800 nm, and more preferably 50 nm or larger, and more preferably 500 nm or smaller.

The average primary particle diameter of the PTFE can be determined by measuring a transmittance of projected light of 500 nm in wavelength for a unit length of an aqueous dispersion of the PTFE so diluted with water that the solid content becomes 0.22% by mass, and using a calibration curve of a PTFE number base average primary particle diameter previously obtained by measurement of the unidirectional particle diameters in a transmission electron microscopic photograph vs. the above transmittance.

In one embodiment, secondary particles of the PTFE can be used. The secondary particles of the PTFE are particles formed by aggregation of the primary particles of the PTFE.

The average secondary particle diameter of the PTFE is preferably 1 to 2,000 μm.

The secondary particle diameter of the PTFE can be measured according to ASTM D4895.

### (Fluorine-Containing Copolymer)

The fluorine-containing copolymer contained in the composition of the present disclosure is a melt-processible fluororesin. The melt-processibility means that it is possible for a polymer to be melted and processed by using a conventional processing device such as an extruding machine or an injection molding machine.

The fluorine-containing copolymer contained in the composition of the present disclosure comprises tetrafluoroethylene (TFE) unit, hexafluoropropylene (HFP) unit and perfluoro(propyl vinyl ether) (PPVE) unit.

The content of HFP unit of the fluorine-containing copolymer is, with respect to the whole of the monomer units constituting the fluorine-containing copolymer, 8.5 to 11.2% by mass, and preferably 8.8% by mass or higher, more preferably 9.0% by mass or higher, still more preferably 9.1% by mass or higher, further still more preferably 9.2% by mass or higher, further still more preferably 9.3% by mass or higher, especially preferably 9.4% by mass or higher, further especially preferably 9.5% by mass or higher and most preferably 9.7% by mass or higher, and preferably 11.1% by mass or lower, more preferably 11.0% by mass or lower, still more preferably 10.9% by mass or lower and especially preferably 10.8% by mass or lower. When the content of HFP unit is too low, in the case where injection molded articles are obtained by molding the composition by an injection molding method, the injection molded articles are easily flawed. Further, when the content of HFP unit is too low, excellent coating film formability and electric wire coating formability cannot be acquired and formed articles excellent in the stress crack resistance cannot be obtained. When the content of HFP unit is too high, in molding the composition by an injection molding method, it becomes difficult for an injection molded article to be removed from a mold and the injection molded article is inferior in the productivity. Further, when the content of HFP unit is too high, formed articles excellent in the deformation resistance to high temperatures and high loads, and the durability to repeated stress loads cannot be obtained.

The content of PPVE unit of the fluorine-containing copolymer is, with respect to the whole of the monomer units constituting the fluorine-containing copolymer, 0.5 to 2.0% by mass, and preferably 0.6% by mass or higher and more preferably 0.7% by mass or higher, and preferably 1.9% by mass or lower, more preferably 1.8% by mass or lower, still more preferably 1.7% by mass or lower and especially preferably 1.6% by mass or lower. When the content of PPVE unit is too low, in the case where injection molded articles are obtained by molding the composition by an injection molding method, delamination is easily generated. Further, when the content of PPVE unit is too low, excellent electric wire coating formability cannot be acquired and formed articles excellent in the stress crack resistance cannot be obtained. When the content of PPVE unit is too high, in the case where injection molded articles are obtained by molding the composition by an injection molding method, fibrous streaks are easily generated on the injection molded articles. Further, when the content of PPVE unit is too high, in molding the composition by an injection molding method, it becomes difficult for an injection molded article to be removed from a mold and the injection molded article is inferior in the productivity. Further, when the content of PPVE unit is too high, formed articles excellent in the deformation resistance to high temperatures and high loads, and the deformation resistance to tensile stress cannot be obtained.

The content of TFE unit of the fluorine-containing copolymer is, with respect to the whole of the monomer units constituting the fluorine-containing copolymer, preferably 86.8% by mass or higher, more preferably 86.9% by mass or higher, still more preferably 87.0% by mass or higher, further still more preferably 87.1% by mass or higher, further still more preferably 87.2% by mass or higher, especially preferably 87.4% by mass or higher and most preferably 87.6% by mass or higher, and preferably 91.0% by mass or lower, more preferably 90.7% by mass or lower, still more preferably 90.3% by mass or lower, further still more preferably 90.0% by mass or lower, further still more preferably 89.9% by mass or lower, especially preferably 89.8% by mass or lower and most preferably 89.6% by mass or lower. Then, the content of TFE unit may be selected so that the total of contents of HFP unit, PPVE unit, TFE unit and other monomer units becomes 100% by mass.

The fluorine-containing copolymer is not limited as long as the copolymer contains the above three monomer units, and may be a copolymer containing only the above three monomer units, or may be a copolymer containing the above three monomer units and other monomer units.

The other monomers are not limited as long as being copolymerizable with TFE, HFP and PPVE, and may be fluoromonomers or fluorine-non-containing monomers.

It is preferable that the fluoromonomer is at least one selected from the group consisting of chlorotrifluoroethylene, vinyl fluoride, vinylidene fluoride, trifluoroethylene, hexafluoroisobutylene, monomers represented by CH₂═CZ¹(CF₂)ₙZ² (wherein Z¹ is H or F, Z² is H, F or Cl, and n is an integer of 1 to 10), perfluoro(alkyl vinyl ether)s [PAVE] represented by CF₂═CF—ORf¹ (wherein Rf¹ is a perfluoroalkyl group having 1 to 8 carbon atoms) (here, excluding PPVE), alkyl perfluorovinyl ether derivatives represented by CF₂=CF—O—CH₂—Rf² (wherein Rf² is a perfluoroalkyl group having 1 to 5 carbon atoms), perfluoro-2,2-dimethyl-1,3-dioxol [PDD], and perfluoro-2-methylene-4-methyl-1,3-dioxolane [PMD].

The monomers represented by CH₂=CZ¹(CF₂)ₙZ² include CH₂═CFCF₃, CH₂=CH—C₄F₉, CH₂=CH—C₆F₁₃, and CH₂=CF—C₃F₆H.

The perfluoro(alkyl vinyl ether)s represented by CF₂=CF—ORf¹ include CF₂═CF—OCF₃ and CF₂=CF—OCF₂CF₃.

The fluorine-non-containing monomers include hydrocarbon-based monomers copolymerizable with TFE, HFP and PPVE. Examples of the hydrocarbon-based monomers include alkenes such as ethylene, propylene, butylene, and isobutylene; alkyl vinyl ethers such as ethyl vinyl ether, propyl vinyl ether, butyl vinyl ether, isobutyl vinyl ether, and cyclohexyl vinyl ether; vinyl esters such as vinyl acetate, vinyl propionate, n-vinyl butyrate, vinyl isobutyrate, vinyl valerate, vinyl pivalate, vinyl caproate, vinyl caprylate, vinyl caprate, vinyl versatate, vinyl laurate, vinyl myristate, vinyl palmitate, vinyl stearate, vinyl benzoate, vinyl para-t-butylbenzoate, vinyl cyclohexanecarboxylate, vinyl monochloroacetate, vinyl adipate, vinyl acrylate, vinyl methacrylate, vinyl crotonate, vinyl sorbate, vinyl cinnamate, vinyl undecylenate, vinyl hydroxyacetate, vinyl hydroxypropionate, vinyl hydroxybutyrate, vinyl hydroxyvalerate, vinyl hydroxyisobutyrate, and vinyl hydroxycyclohexanecarboxylate; alkyl allyl ethers such as ethyl allyl ether, propyl allyl ether, butyl allyl ether, isobutyl allyl ether, and cyclohexyl allyl ether; and alkyl allyl esters such as ethyl allyl ester, propyl allyl ester, butyl allyl ester, isobutyl allyl ester, and cyclohexyl allyl ester.

The fluorine-non-containing monomers may also be functional group-containing hydrocarbon-based monomers copolymerizable with TFE, HFP and PPVE. Examples of the functional group-containing hydrocarbon-based monomers include hydroxyalkyl vinyl ethers such as hydroxyethyl vinyl ether, hydroxypropyl vinyl ether, hydroxybutyl vinyl ether, hydroxyisobutyl vinyl ether, and hydroxycyclohexyl vinyl ether; fluorine-non-containing monomers having a glycidyl group, such as glycidyl vinyl ether and glycidyl allyl ether; fluorine-non-containing monomers having an amino group, such as aminoalkyl vinyl ethers and aminoalkyl allyl ethers; fluorine-non-containing monomers having an amido group, such as (meth)acrylamide and methylolacrylamide; bromine-containing olefins, iodine-containing olefins, bromine-containing vinyl ethers, and iodine-containing vinyl ethers; and fluorine-non-containing monomers having a nitrile group.

The content of the other monomer units in the fluorine-containing copolymer is, with respect to the whole of the monomer units constituting the fluorine-containing copolymer, preferably 0 to 4.2% by mass, and more preferably 2.8% by mass or lower, still more preferably 1.0% by mass or lower, especially preferably 0.5% by mass or lower and most preferably 0.1% by mass or lower.

The melt flow rate (MFR) of the fluorine-containing copolymer is 13.0 to 42.0 g/10 min, and preferably 14.0 g/10 min or higher, more preferably 15.0 g/10 min or higher, still more preferably 17.0 g/10 min or higher, further still more preferably 18.0 g/10 min or higher, further still more preferably 19.0 g/10 min or higher, especially preferably 21.0 g/10 min or higher, further especially preferably 22.0 g/10 min or higher and most preferably 23.0 g/10 min or higher, and preferably 41.0 g/10 min or lower, more preferably 40.0 g/10 min or lower, still more preferably 39.0 g/10 min or lower, further still more preferably 38.0 g/10 min or lower, especially preferably 37.0 g/10 min or lower and most preferably 36.5 g/10 min or lower. When the MFR is too low, in the case where injection molded articles are obtained by molding the composition by an injection molding method, flow marks are easily generated and delamination is easily generated. Further, when the MFR is too low, excellent coating film formability and electric wire coating formability cannot be acquired and formed articles excellent in the deformation resistance to tensile stress cannot be obtained. When the MFR is too high, in the case where injection molded articles are obtained by molding the composition by an injection molding method, fibrous streaks are easily generated on the injection molded articles. Further, when the MFR is too high, excellent coating film formability and electric wire coating formability cannot be acquired and formed articles excellent in the stress crack resistance cannot be obtained.

In the present disclosure, the MFR is a value obtained as a mass (g/10 min) of a polymer flowing out from a die of 2 mm in inner diameter and 8 mm in length per 10 min at 372° C. under a load of 5 kg using a melt indexer G-01 (manufactured by Toyo Seiki Seisaku-sho Ltd.), according to ASTM D1238.

The MFR can be regulated by regulating the kind and amount of a polymerization initiator to be used in polymerization of monomers, the kind and amount of a chain transfer agent, and the like.

The fluorine-containing copolymer may or may not have a carbonyl group-containing terminal group, —CF═CF₂ or —CH₂OH. In one embodiment of the fluorine-containing copolymer, the total number of a carbonyl group-containing terminal group, —CF═CF₂ and —CH₂OH is 90 or less per 10⁶ main-chain carbon atoms. The total number of the carbonyl group-containing terminal group, —CF═CF₂ and —CH₂OH can be regulated, for example, by suitable selection of the kind of a polymerization initiator or a chain transfer agent, or by a wet heat treatment or fluorination treatment of the fluorine-containing copolymer described later.

The carbonyl group-containing terminal groups are for example, —COF, —COOH, —COOR (R is an alkyl group), —CONH₂, and —O(C═O)O—R (R is an alkyl group). The kinds of the alkyl groups (R) —COOR and —O(C═O)O—R have are determined depending on a polymerization initiator or a chain transfer agent used in production of the fluorine-containing copolymer, and are, for example, alkyl groups having 1 to 6 carbon atoms, such as —CH₃.

The fluorine-containing copolymer may or may not have —CF₂H. In one embodiment of the fluorine-containing copolymer, the number of —CF₂H is 50 or more per 10⁶ main-chain carbon atoms. The number of —CF₂H can be regulated, for example, by suitable selection of the kind of a polymerization initiator or a chain transfer agent, or by a wet heat treatment or fluorination treatment of the fluorine-containing copolymer described later.

For identification of the kind of the functional groups and measurement of the number of the functional groups, infrared spectroscopy can be used.

The number of the functional groups is measured, specifically, by the following method. First, the fluorine-containing copolymer is molded by cold press to prepare a film of 0.25 to 0.30 mm in thickness. The film is analyzed by Fourier transform infrared spectroscopy to obtain an infrared absorption spectrum, and a difference spectrum against a base spectrum that is completely fluorinated and has no functional groups is obtained. From an absorption peak of a specific functional group observed on this difference spectrum, the number N of the functional group per 1×10⁶ carbon atoms in the fluorine-containing copolymer is calculated according to the following formula (A).

$$N = I \times K / t \qquad ( A )$$

I: absorbance
K: correction factor
t: thickness of film (mm)

For reference, for some functional groups, the absorption frequency, the molar absorption coefficient and the correction factor are shown in Table 1. Then, the molar absorption coefficients are those determined from FT-IR measurement data of low molecular model compounds.

TABLE 1

| | | Molar | | |
|---|---|---|---|---|
| | Absorption | Extinction | | |
| Functional | Frequency | Coefficient | Correction | Model |
| Group | (cm⁻¹) | (l/cm/mol) | Factor | Compound |
| —COF | 1883 | 600 | 388 | C₇F₁₅COF |
| —COOH | 1815 | 530 | 439 | H(CF₂)₆COOH |
| free | | | | |
| —COOH | 1779 | 530 | 439 | H(CF₂)₆COOH |
| bonded | | | | |
| —COOCH₃ | 1795 | 680 | 342 | C₇F₁₅COOCH₃ |
| —CONH₂ | 3436 | 506 | 460 | C₇H₁₅CONH₂ |
| —CH₂OH₂, | 3648 | 104 | 2236 | C₇H₁₅CH₂OH |
| —OH | | | | |
| —CF₂H | 3020 | 8.8 | 26485 | H(CF₂CF₂)₃CH₂OH |
| —CF═CF₂ | 1795 | 635 | 366 | CF₂═CF₂ |

Absorption frequencies of —CH₂CF₂H, —CH₂COF, —CH₂COOH, —CH₂COOCH₃ and —CH₂CONH₂ are lower by a few tens of kaysers (cm⁻¹) than those of —CF₂H, —COF, —COOH free and —COOH bonded, —COOCH₃ and —CONH₂ shown in the Table, respectively.

For example, the number of the functional group —COF is the total of the number of a functional group determined from an absorption peak having an absorption frequency of 1,883 cm⁻¹ derived from —CF₂COF and the number of a functional group determined from an absorption peak having an absorption frequency of 1,840 cm⁻¹ derived from —CH₂COF.

The number of —CF₂H groups can also be determined from a peak integrated value of the —CF₂H group acquired in a ¹⁹F-NMR measurement using a nuclear magnetic resonance spectrometer and set at a measurement temperature of (the melting point of a polymer+20° C.)

Functional groups such as a —CF₂H group are functional groups present on the main chain terminals or side chain terminals of the fluorine-containing copolymer, and functional groups present on the main chain or the side chains thereof. These functional groups are introduced to the fluorine-containing copolymer, for example, by a chain transfer agent or a polymerization initiator used in production of the fluorine-containing copolymer. For example, in the case of using an alcohol as the chain transfer agent, or a peroxide having a structure of —CH₂OH as the polymerization initiator, —CH₂OH is introduced on the main chain terminals of the fluorine-containing copolymer. Alternatively, the functional group is introduced on the side chain terminal of the fluorine-containing copolymer by polymerizing a monomer having the functional group.

By carrying out a treatment such as a wet heat treatment or a fluorination treatment on the fluorine-containing copolymer having such functional groups, there can be obtained the fluorine-containing copolymer having the number of functional groups in the above range.

The melting point of the fluorine-containing copolymer is preferably 220 to 290° C. and more preferably 240 to 280° C., because the injection moldability of the composition is more improved.

The melting point of the fluorine-containing copolymer can be measured by using a differential scanning calorimeter [DSC].

The fluorine-containing copolymer can be produced by any polymerization method of bulk polymerization, suspension polymerization, solution polymerization, emulsion polymerization and the like. In these polymerization methods, conditions such as temperature and pressure, a polymerization initiator, a chain transfer agent, a solvent and other additives can suitably be set depending on the composition and the amount of a desired fluorine-containing copolymer.

The polymerization initiator may be an oil-soluble radical polymerization initiator or a water-soluble radical initiator.

An oil-soluble radical polymerization initiator may be a known oil-soluble peroxide, and examples thereof typically include:
dialkyl peroxycarbonates such as di-n-propyl peroxydicarbonate, diisopropyl peroxydicarbonate, di-sec-butyl peroxydicarbonate;
peroxyesters such as t-butyl peroxyisobutyrate and t-butyl peroxypivalate;
dialkyl peroxides such as di-t-butyl peroxide; and di[fluoro(or fluorochloro)acyl]peroxides.

The di[fluoro(or fluorochloro)acyl]peroxides include diacyl peroxides represented by [(RfCOO)—]₂ wherein Rf is a perfluoroalkyl group, an ω-hydroperfluoroalkyl group or a fluorochloroalkyl group.

Examples of the di[fluoro(or fluorochloro)acyl]peroxides include di(ω-hydroperfluorohexanoyl) peroxide, di(ω-hydro-dodecafluoroheptanoyl) peroxide, di(ω)-hydro-tetradecafluorooctanoyl) peroxide, di(ω)-hydrohexadecafluorononanoyl) peroxide, di(perfluorobutyryl) peroxide, di(perfluorovaleryl) peroxide, di(perfluorohexanoyl) peroxide, di(perfluoroheptanoyl) peroxide, di(perfluorooctanoyl) peroxide, di(perfluorononanoyl) peroxide, di(ω)-chloro-hexafluorobutyryl) peroxide, di(ω-chloro-decafluorohexanoyl) peroxide, di(ω)-chloro-tetradecafluorooctanoyl) peroxide, ω-hydro-dodecafluoroheptanoyl-ω-hydrohexadecafluorononanoyl peroxide, ω-chloro-hexafluorobutyryl-ω-chloro-decafluorohexanoyl peroxide, ω-hydrododecafluoroheptanoyl-perfluorobutyryl peroxide, di(dichloropentafluorobutanoyl) peroxide, di(trichlorooctafluorohexanoyl) peroxide, di(tetrachloroundecafluorooctanoyl) peroxide, di(pentachlorotetradecafluorodecanoyl) peroxide and di(undecachlorotriacontafluorodocosanoyl) peroxide.

The water-soluble radical polymerization initiator may be a well known water-soluble peroxide, and examples thereof include ammonium salts, potassium salts and sodium salts of persulfuric acid, perboric acid, perchloric acid, perphosphoric acid, percarbonic acid and the like, and t-butyl permaleate and t-butyl hydroperoxide. A reductant such as a sulfite salt may be combined with a peroxide and used, and the amount thereof to be used may be 0.1 to 20 times with respect to the peroxide.

Use of an oil-soluble radical polymerization initiator as the polymerization initiator is preferable, because of enabling avoidance of the formation of —COF and —COOH, and enabling easy regulation of the total number of —COF and —COOH of the fluorine-containing copolymer in the above-mentioned range. Further, use of the oil-soluble radical polymerization initiator is likely to make it easy also for the carbonyl group-containing terminal group and —CH₂OH to be regulated in the above-mentioned range. It is especially suitable that the fluorine-containing copolymer is produced by suspension polymerization using the oil-soluble radical polymerization initiator. The oil-soluble radical polymerization initiator is preferably at least one selected from the group consisting of dialkyl peroxycarbonates and di[fluoro(or fluorochloro)acyl]peroxides, and more preferably at least one selected from the group consisting of di-n-propyl peroxydicarbonate, diisopropyl peroxydicarbonate, and di(ω)-hydro-dodecafluoroheptanoyl) peroxide.

Examples of the chain transfer agent include hydrocarbons such as ethane, isopentane, n-hexane and cyclohexane; aromatics such as toluene and xylene; ketones such as acetone; acetates such as ethyl acetate and butyl acetate; alcohols such as methanol, ethanol and 2,2,2-trifluoroethanol; mercaptans such as methyl mercaptan; halogenated hydrocarbons such as carbon tetrachloride, chloroform, methylene chloride and methyl chloride; and 3-fluorobenzotrifluoride. The amount thereof to be added can vary depending on the magnitude of the chain transfer constant of a compound to be used, but the chain transfer agent is used usually in the range of 0.01 to 20 parts by mass with respect to 100 parts by mass of a solvent.

For example, in the cases of using a dialkyl peroxycarbonate, a di[fluoro(or fluorochloro)acyl]peroxide or the like as a polymerization initiator, although there are some cases where the molecular weight of an obtained fluorine-containing copolymer becomes too high and the regulation of the melt flow rate to a desired one is not easy, the molecular weight can be regulated by using the chain transfer agent. It is especially suitable that the fluorine-containing copolymer is produced by suspension polymerization using the chain transfer agent such as an alcohol and the oil-soluble radical polymerization initiator.

The solvent includes water and mixed solvents of water and an alcohol. A monomer to be used for the polymerization of the fluorine-containing copolymer can also be used as the solvent.

In the suspension polymerization, in addition to water, a fluorosolvent may be used. The fluorosolvent may include hydrochlorofluoroalkanes such as CH₃CClF₂, CH₃CCl₂F, CF₃CF₂CCl₂H and CF₂ClCF₂CFHCl; chlorofluoroalaknes such as CF₂ClCFClCF₂CF₃ and CF₃CFClCFClCF₃; and perfluoroalkanes such as perfluorocyclobutane, CF₃CF₂CF₂CF₃, CF₃CF₂CF₂CF₂CF₃ and CF₃CF₂CF₂CF₂CF₂CF₃, and among these, perfluoroalkanes are preferred. The amount of the fluorosolvent to be used is, from the viewpoint of the suspensibility and the economic efficiency, preferably 10 to 100 parts by mass with respect to 100 parts by mass of the solvent.

The polymerization temperature is not limited, and may be 0 to 100° C. In the case where the decomposition rate of the polymerization initiator is too high, including cases of using a dialkyl peroxycarbonate, a di[fluoro(or fluorochloro)acyl]peroxide or the like as the polymerization initiator, it is preferable to adopt a relatively low polymerization temperature such as in the temperature range of 0 to 35° C.

The polymerization pressure can suitably be determined according to other polymerization conditions such as the kind of the solvent to be used, the amount of the solvent, the vapor pressure and the polymerization temperature, but usually may be 0 to 9.8 MPaG. The polymerization pressure is preferably 0.1 to 5 MPaG, more preferably 0.5 to 2 MPaG and still more preferably 0.5 to 1.5 MPaG. When the polymerization pressure is 1.5 MPaG or higher, the production efficiency can be improved.

Examples of the additives in the polymerization include suspension stabilizers. The suspension stabilizers are not limited as long as being conventionally well-known ones, and methylcellulose, polyvinyl alcohols and the like can be used. With the use of a suspension stabilizer, suspended particles produced by the polymerization reaction are dispersed stably in an aqueous medium, and therefore the suspended particles hardly adhere on the reaction vessel even when a SUS-made reaction vessel not having been subjected to adhesion preventing treatment such as glass lining is used. Accordingly, a reaction vessel withstanding a high pressure can be used, and therefore the polymerization under a high pressure becomes possible and the production efficiency can be improved. By contrast, in the case of carrying out the polymerization without using the suspension stabilizer, the suspended particles may adhere and the production efficiency may be lowered with the use of a SUS-made reaction vessel not having been subjected to adhesion preventing treatment is used. The concentration of the suspension stabilizer in the aqueous medium can suitably be regulated depending on conditions.

In the case of obtaining an aqueous dispersion containing the fluorine-containing copolymer by the polymerization reaction, a dry fluorine-containing copolymer may be recovered by coagulating, washing and drying the fluorine-containing copolymer contained in the aqueous dispersion. Then, in the case of obtaining the fluorine-containing copolymer as a slurry by the polymerization reaction, a dry fluorine-containing copolymer may be recovered by taking out the slurry from a reaction vessel and washing and drying the slurry. The fluorine-containing copolymer can be recovered in a powder form by the drying.

The fluorine-containing copolymer obtained by the polymerization may be formed into pellets. A method of forming into pellets is not limited, and a conventionally known method can be used. Examples thereof include methods of melt extruding the fluorine-containing copolymer by using a single-screw extruder, a twin-screw extruder or a tandem extruder and cutting the resultant into a predetermined length to form the fluorine-containing copolymer into pellets. The extrusion temperature in the melt extrusion needs to be varied depending on the melt viscosity and the production method of the fluorine-containing copolymer, and is preferably the melting point of the fluorine-containing copolymer+20° C. to the melting point of the fluorine-containing copolymer+140° C. A method of cutting the fluorine-containing copolymer is not limited, and there can be adopted a conventionally known method such as a strand cut method, a hot cut method, an underwater cut method, or a sheet cut method. Volatile components in the obtained pellets may be removed by heating the pellets (degassing treatment). Alternatively, the obtained pellets may be treated by bringing the pellets into contact with hot water of 30 to 200° C., steam of 100 to 200° C. or hot air of 40 to 200° C.

The fluorine-containing copolymer obtained by the polymerization may be heated in the presence of air and water at a temperature of 100° C. or higher (wet heat treatment). Examples of the wet heat treatment include a method in which by using an extruder, the fluorine-containing copolymer obtained by the polymerization is melted and extruded while air and water are fed. The wet heat treatment can convert thermally unstable functional groups of the fluorine-containing copolymer, such as —COF and —COOH, to thermally relatively stable —CF₂H. By heating the fluorine-containing copolymer, in addition to air and water, in the presence of an alkali metal salt, the conversion reaction to —CF₂H can be promoted. Depending on applications of the fluorine-containing copolymer, however, it should be paid regard to that contamination by the alkali metal salt must be avoided.

The fluorine-containing copolymer obtained by the polymerization may be subjected to a fluorination treatment, or may not be subjected to a fluorination treatment. The fluorination treatment can be carried out by bringing the fluorine-containing copolymer subjected to no fluorination treatment into contact with a fluorine-containing compound. The fluorination treatment can convert thermally unstable functional groups of the fluorine-containing copolymer, such as the carbonyl group-containing terminal groups and —CH₂OH, and thermally relatively stable functional groups thereof, such as —CF₂H, to thermally very stable —CF₃.

The fluorine-containing compound is not limited, but includes fluorine radical sources generating fluorine radicals under the fluorination treatment condition. The fluorine radical sources include F₂ gas, CoF₃, AgF₂, UF₆, OF₂, N₂F₂, CF₃OF, halogen fluorides (for example, IF₅ and ClF₃).

The fluorine radical source such as F₂ gas may be, for example, one having a concentration of 100%, but from the viewpoint of safety, the fluorine radical source is preferably mixed with an inert gas and diluted therewith to 5 to 50% by mass, and then used; and it is more preferably to be diluted to 15 to 30% by mass. The inert gas includes nitrogen gas, helium gas and argon gas, but from the viewpoint of the economic efficiency, nitrogen gas is preferred.

The condition of the fluorination treatment is not limited, and the fluorine-containing copolymer in a melted state may be brought into contact with the fluorine-containing compound, but the fluorination treatment can be carried out usually at a temperature of not higher than the melting point of the fluorine-containing copolymer, preferably at 20 to 220° C. and more preferably at 100 to 200° C. The fluorination treatment is carried out usually for 1 to 30 hours and preferably 5 to 25 hours. The fluorination treatment is preferred which brings the fluorine-containing copolymer having been subjected to no fluorination treatment into contact with fluorine gas (F₂ gas).

### (Constitution of the Composition)

The content of the PTFE in the composition is, with respect to the mass of the composition, 0.03 to 0.30% by mass, and preferably 0.04% by mass or higher and more preferably 0.05% by mass or higher, and preferably 0.25% by mass or lower, more preferably 0.20% by mass or lower, still more preferably 0.19% by mass or lower, further still more preferably 0.17% by mass or lower, further still more preferably 0.15% by mass or lower, especially preferably 0.13% by mass or lower and most preferably 0.12% by mass or lower. When the content of the PTFE is too low, in the case where injection molded articles are obtained by molding the composition by an injection molding method, delamination is easily generated. Further, when the content of the PTFE is too low, formed articles excellent in the deformation resistance to high temperatures and high loads and the durability to repeated stress loads cannot be obtained. When the content of the PTFE is too high, in the case where injection molded articles are obtained by molding the composition by an injection molding method, fibrous streaks are easily generated on the injection molded articles. Further, when the content of the PTFE is too high, excellent coating film formability and electric wire coating formability cannot be acquired and formed articles excellent in the stress crack resistance cannot be obtained.

The composition may contain other components different from the PTFE and the above-mentioned fluorine-containing copolymer. The other components include fillers, plasticizers, processing aids, mold release agents, pigments, flame retarders, lubricants, light stabilizers, weathering stabilizers, electrically conductive agents, antistatic agents, ultraviolet absorbents, antioxidants, foaming agents, perfumes, oils, softening agents and dehydrofluorination agents.

Examples of the fillers include silica, kaolin, clay, organo clay, talc, mica, alumina, calcium carbonate, calcium terephthalate, titanium oxide, calcium phosphate, calcium fluoride, lithium fluoride, crosslinked polystyrene, potassium titanate, carbon, boron nitride, carbon nanotube and glass fiber. The electrically conductive agents include carbon black. The plasticizers include dioctyl phthalate and pentaerythritol. The processing aids include carnauba wax, sulfone compounds, low molecular weight polyethylene and fluorine-based auxiliary agents. The dehydrofluorination agents include organic oniums and amidines.

Then, the other components may be other polymers other than PTFE and the above-mentioned fluorine-containing copolymer. The other polymers include fluororesins other than PTFE and the above fluorine-containing copolymer, fluoroelastomers and non-fluorinated polymers.

Methods for producing the composition include a method of dry mixing the PTFE and the fluorine-containing copolymer, a method of previously mixing the PTFE and the fluorine-containing copolymer by a mixing machine, and then melt kneading the mixture by a kneader, a melt extruder or the like, and a method of preparing an aqueous dispersion containing the PTFE and the fluorine-containing copolymer, and co-coagulating the PTFE and the fluorine-containing copolymer.

The composition may be produced by preparing a composition (master batch) containing the PTFE in a relatively large amount and the fluorine-containing copolymer, and further mixing the obtained composition with the fluorine-containing copolymer. Methods of producing the composition (master batch) include a method of previously mixing the PTFE and the fluorine-containing copolymer by a mixing machine, and then melt kneading the mixture by a kneader, a melt extruder or the like, and a method of preparing an aqueous dispersion containing the PTFE and the fluorine-containing copolymer, and co-coagulating the PTFE and the fluorine-containing copolymer. Examples of methods of mixing the obtained composition (master batch) with the fluorine-containing copolymer include a method of dry mixing the both, and a method of melt kneading the both by using a kneader, a melt extruder or the like.

After the preparation of the composition containing the PTFE and the fluorine-containing copolymer, a wet heat treatment or a fluorination treatment may be carried out on the obtained composition. The wet heat treatment and the fluorination treatment of the composition can be carried out by the same methods as the methods of the wet heat treatment and the fluorination treatment of the fluorine-containing copolymer.

The shape of the composition is not especially limited, and may be powder, pellets or the like.

### (Molding and Applications of the Composition)

The composition of the present disclosure can be used as molding materials, and can suitably be used particularly as molding materials to be used in an injection molding method. Molded articles can be obtained by molding the composition of the present disclosure. The molded articles containing the composition of the present disclosure are excellent in beauty and excellent also in the deformation resistance to high temperatures and high loads.

The composition of the present disclosure can be used also as powder coating materials. In the case where the composition is obtained as a powder by the above-mentioned production method, the obtained powder can be used as it is as a powder coating material. In the case where the composition is not obtained as a powder by the above-mentioned production method, a powder coating material can be produced, for example, by producing the composition, thereafter compressing the obtained composition into a sheet shape by a roll, crushing the resultant by a crusher, and classifying the resultant. The average particle diameter of the powder coating material is preferably 10 to 1,000 μm. The powder coating material is applied usually by applying it on a coating target and thereafter heating and firing to form a film. The coating film thus obtained can be used as corrosion-resistant linings and the like in various applications.

A method of forming the composition is not limited, and includes injection molding, extrusion forming, compression molding, blow molding, transfer molding, rotomolding and rotolining molding. As the forming method, among these, preferable are extrusion forming, compression molding, injection molding and transfer molding; from the viewpoint of being able to produce formed articles in a high productivity, more preferable are injection molding, extrusion forming and transfer molding, and still more preferable is injection molding. That is, it is preferable that formed articles are extrusion formed articles, compression molded articles, injection molded articles or transfer molded articles; and from the viewpoint of being able to produce formed articles in a high productivity, being injection molded articles, extrusion formed articles or transfer molded articles is more preferable, and being injection molded articles is still more preferable. By molding the composition of the present disclosure by an injection molding method, beautiful molded articles can be obtained.

Further, from the composition of the present disclosure, formed articles excellent in the deformation resistance to high temperatures and high loads, the stress crack resistance, the deformation resistance to tensile stress and the durability to repeated stress loads can be obtained.

The tensile elastic modulus at 105° C. of the formed article of the present disclosure is preferably 50.0 MPa or higher, more preferably 51.0 MPa or higher, still more preferably 53.0 MPa or higher, further still more preferably 54.0 MPa or higher, further still more preferably 55.0 MPa or higher, especially preferably 56.0 MPa or higher and most preferably 57.0 MPa or higher. A formed article high in the tensile elastic modulus is excellent in the deformation resistance to tensile stress.

The tensile strength at the timepoint of 320,000 cycles of the formed article of the present disclosure is preferably 5.30 N or higher, more preferably 5.40 N or higher and still more preferably 5.50 N or higher. A formed article high in the tensile strength at the timepoint of 320,000 cycles is excellent in the durability to repeated stress loads.

Formed articles may be, for example, nuts, bolts, joints, films, bottles, gaskets, electric wire coatings, tubes, hoses, pipes, valves, sheets, seals, packings, tanks, rollers, containers, cocks, connectors, filter housings, filter cages, flowmeters, pumps, wafer carriers, and wafer boxes.

The composition of the present disclosure or the above formed articles can be used, for example, in the following applications.

Food packaging films, and members for liquid transfer for food production apparatuses, such as lining materials of fluid transfer lines, packings, sealing materials and sheets, used in food production processes;
chemical stoppers and packaging films for chemicals, and members for chemical solution transfer, such as lining materials of liquid transfer lines, packings, sealing materials and sheets, used in chemical production processes; inner surface lining materials of chemical solution tanks and piping of chemical plants and semiconductor factories; members for fuel transfer, such as 0 (square) rings, tubes, packings, valve stem materials, hoses and sealing materials, used in fuel systems and peripheral equipment of automobiles, and such as hoses and sealing materials, used in ATs of automobiles;
members used in engines and peripheral equipment of automobiles, such as flange gaskets of carburetors, shaft seals, valve stem seals, sealing materials and hoses, and other vehicular members such as brake hoses, hoses for air conditioners, hoses for radiators, and electric wire coating materials;
members for chemical transfer for semiconductor production apparatuses, such as O (square) rings, tubes, packings, valve stem materials, hoses, sealing materials, rolls, gaskets, diaphragms and joints;
members for coating and inks, such as coating rolls, hoses and tubes, for coating facilities, and containers for inks; members for food and beverage transfer, such as tubes, hoses, belts, packings and joints for food and beverage, food packaging materials, and members for glass cooking appliances; members for waste liquid transport, such as tubes and hoses for waste transport;
members for high-temperature liquid transport, such as tubes and hoses for high-temperature liquid transport; members for steam piping, such as tubes and hoses for steam piping;
corrosion proof tapes for piping, such as tapes wound on piping of decks and the like of ships;
various coating materials, such as electric wire coating materials, optical fiber coating materials, and transparent front side coating materials installed on the light incident side and back side lining materials of photoelectromotive elements of solar cells;
diaphragms and sliding members such as various types of packings of diaphragm pumps;
films for agriculture, and weathering covers for various kinds of roof materials, sidewalls and the like;
interior materials used in the building field, and coating materials for glasses such as non-flammable fireproof safety glasses; and lining materials for laminate steel sheets used in the household electric field.

The fuel transfer members used in fuel systems of automobiles further include fuel hoses, filler hoses and evap hoses. The above fuel transfer members can also be used as fuel transfer members for gasoline additive-containing fuels, resultant to sour gasoline, resultant to alcohols, and resultant to methyl tertiary butyl ether and amines and the like.

The above chemical stoppers and packaging films for chemicals have excellent chemical resistance to acids and the like. The above chemical solution transfer members also include corrosion proof tapes wound on chemical plant pipes.

The above formed articles also include vehicular radiator tanks, chemical solution tanks, bellows, spacers, rollers and gasoline tanks, waste solution transport containers, high-temperature liquid transport containers and fishery and fish farming tanks.

The above formed articles further include members used for vehicular bumpers, door trims and instrument panels, food processing apparatuses, cooking devices, water- and oil-repellent glasses, illumination-related apparatuses, display boards and housings of OA devices, electrically illuminated billboards, displays, liquid crystal displays, cell phones, printed circuit boards, electric and electronic components, sundry goods, dust bins, bathtubs, unit baths, ventilating fans, illumination frames and the like.

The formed articles can suitably be utilized as members to be compressed such as gaskets and packings. The members to be compressed may be gaskets or packings.

The size and shape of the members to be compressed may suitably be set according to applications, and are not limited. The shape of the members to be compressed may be, for example, annular. The members to be compressed may also have, in plan view, a circular shape, an elliptic shape, a corner-rounded square or the like, and may be a shape having a throughhole in the central portion thereof.

It is preferable that the members to be compressed are used as members constituting non-aqueous electrolyte batteries. The members to be compressed are especially suitable as members to be used in the state of contacting with non-aqueous electrolytes in non-aqueous electrolyte batteries. That is, the members to be compressed may also be ones having a liquid-contact surface with a non-aqueous electrolyte in the non-aqueous electrolyte batteries.

The non-aqueous electrolyte batteries are not limited as long as being batteries having a non-aqueous electrolyte, and examples thereof include lithium ion secondary batteries and lithium ion capacitors. Members constituting the non-aqueous electrolyte batteries include sealing members and insulating members.

For the non-aqueous electrolyte, one or two or more of well-known solvents can be used such as propylene carbonate, ethylene carbonate, butylene carbonate, γ-butyllactone, 1,2-dimethoxyethane, 1,2-diethoxyethane, dimethyl carbonate, diethyl carbonate and ethyl methyl carbonate. The non-aqueous electrolyte batteries may further have an electrolyte. The electrolyte is not limited, but may be LiClO₄, LiAsF₆, LiPF₆, LiBF₄, LiCl, LiBr, CH₃SO₃Li, CF₃SO₃Li, cesium carbonate and the like.

The members to be compressed can suitably be utilized, for example, as sealing members such as sealing gaskets and sealing packings, and insulating members such as insulating gaskets and insulating packings. The sealing members are members to be used for preventing leakage of a liquid or a gas, or penetration of a liquid or a gas from the outside. The insulating members are members to be used for insulating electricity. The members to be compressed may also be members to be used for the purpose of both of sealing and insulation.

The members to be compressed can suitably be used as sealing members for non-aqueous electrolyte solution batteries and insulating members for non-aqueous electrolyte solution batteries. Further, the members to be compressed, due to containing the above composition, have the excellent insulating property. Therefore, in the case of using the members to be compressed as insulating members, the member firmly adheres to two or more electrically conductive members and prevents short circuit over a long term.

The composition of the present disclosure can be utilized suitably as a material for forming an electric wire coating. A coated electric wire having a coating layer containing the composition of the present disclosure is hardly deformed even when being loaded with a load in a high-temperature environment.

The coated electric wire has a core wire, and the coating layer installed on the periphery of the core wire and containing the composition of the present disclosure. For example, an extrusion formed article made by melt extruding the composition in the present disclosure on a core wire can be made into the coating layer. The coated electric wires are suitable for LAN cables (Eathernet Cables), high-frequency transmission cables, flat cables and heat-resistant cables and the like, and particularly, for transmission cables such as LAN cables (Eathernet Cables) and high-frequency transmission cables.

As a material for the core wire, for example, a metal conductor material such as copper or aluminum can be used. The core wire is preferably one having a diameter of 0.02 to 3 mm. The diameter of the core wire is more preferably 0.04 mm or larger, still more preferably 0.05 mm or larger and especially preferably 0.1 mm or larger. The diameter of the core wire is more preferable 2 mm or smaller.

With regard to specific examples of the core wire, there may be used, for example, AWG (American Wire Gauge)-46 (solid copper wire of 40 μm in diameter), AWG-26 (solid copper wire of 404 μm in diameter), AWG-24 (solid copper wire of 510 μm in diameter), and AWG-22 (solid copper wire of 635 μm in diameter).

The coating layer is preferably one having a thickness of 0.1 to 3.0 mm. It is also preferable that the thickness of the coating layer is 2.0 mm or smaller.

The high-frequency transmission cables include coaxial cables. The coaxial cables generally have a structure configured by laminating an inner conductor, an insulating coating layer, an outer conductor layer and a protective coating layer in order from the core part to the peripheral part. A formed article containing the composition of the present disclosure can suitably be utilized as the insulating coating layer. The thickness of each layer in the above structure is not limited, but is usually: the diameter of the inner conductor is approximately 0.1 to 3 mm; the thickness of the insulating coating layer is approximately 0.3 to 3 mm; the thickness of the outer conductor layer is approximately 0.5 to 10 mm; and the thickness of the protective coating layer is approximately 0.5 to 2 mm.

Alternatively, the coating layer may be one containing cells, and is preferably one in which cells are homogeneously distributed.

The average cell size of the cells is not limited, but is, for example, preferably 60 μm or smaller, more preferably 45 μm or smaller, still more preferably 35 μm or smaller, further still more preferably 30 μm or smaller, especially preferable 25 m or smaller and further especially preferably 23 μm or smaller. Then, the average cell size is preferably 0.1 μm or larger and more preferably 1 μm or larger. The average cell size can be determined by taking an electron microscopic image of an electric wire cross section, calculating the diameter of each cell and averaging the diameters.

The foaming ratio of the coating layer may be 20% or higher, and is more preferably 30% or higher, still more preferably 33% or higher and further still more preferably 35% or higher. The upper limit is not limited, but is, for example, 80%. The upper limit of the foaming ratio may be 60%. The foaming ratio is a value determined as ((the specific gravity of an electric wire coating material—the specific gravity of the coating layer)/(the specific gravity of the electric wire coating material)×100. The foaming ratio can suitably be regulated according to applications, for example, by regulation of the amount of a gas, described later, to be injected in an extruder, or by selection of the kind of a gas dissolving.

Alternatively, the coated electric wire may have another layer between the core wire and the coating layer, and may further have another layer (outer layer) on the periphery of the coating layer. In the case where the coating layer contains cells, the electric wire may be of a two-layer structure (skin-foam) in which a non-foaming layer is inserted between the core wire and the coating layer, a two-layer structure (foam-skin) in which a non-foaming layer is coated as the outer layer, or a three-layer structure (skin-foam-skin) in which a non-foaming layer is coated as the outer layer of the skin-foam structure. The non-foaming layer is not limited, and may be a resin layer composed of a resin, such as a TFE/HFP-based copolymer, a TFE/PAVE copolymer, a TFE/ethylene-based copolymer, a vinylidene fluoride-based polymer, a polyolefin resin such as polyethylene [PE], or polyvinyl chloride [PVC].

The coated electric wire can be produced, for example, by heating the composition and extruding the composition in a melted state onto a core wire by using an extruder to form a coating layer.

In the formation of the coating layer, by heating a composition, introducing a gas in the composition in a melted state, the coating layer containing cells can also be formed. As the gas, there can be used, for example, a gas such as chlorodifluoromethane, nitrogen or carbon dioxide, or a mixture thereof. The gas may be introduced as a pressurizing gas in the heated composition, or the gas may be generated by mixing a chemical foaming agent in the composition. The gas is dissolved in the composition in a melted state.

Then, the composition of the present disclosure can suitably be utilized as a material for products for high-frequency signal transmission.

The products for high-frequency signal transmission are not limited as long as being products to be used for transmission of high-frequency signals, and include (1) formed boards such as insulating boards for high-frequency circuits, insulating materials for connection parts and printed circuit boards, (2) formed articles such as bases of high-frequency vacuum tubes and antenna covers, and (3) coated electric wires such as coaxial cables and LAN cables. The products for high-frequency signal transmission can suitably be used in devices utilizing microwaves, particularly microwaves of 3 to 30 GHz, in satellite communication devices, cell phone base stations, and the like.

In the products for high-frequency signal transmission, the composition of the present disclosure can suitably be used as insulators in that the dielectric loss tangent is low.

As the (1) formed boards, printed wiring boards are preferable in that the good electric property is provided. The printed wiring boards are not limited, but examples thereof include printed wiring boards of electronic circuits for cell phones, various computers, communication devices and the like. As the (2) formed articles, antenna covers are preferable in that the dielectric loss is low.

The composition of the present disclosure can suitably be utilized for films.

The films are useful as release films. The release films can be produced by forming the composition of the present disclosure by melt extrusion, calendering, press molding, casting or the like. From the viewpoint that uniform thin films can be obtained, the release films can be produced by melt extrusion.

The films can be applied to roll surfaces used in QA devices. Then, the composition of the present disclosure is formed into needed shapes by extrusion forming, compression molding, press molding or the like to be formed into sheet-shapes, filmy shapes or tubular shapes, and can be used as surface materials for OA device rolls, OA device belts or the like. Thin-wall tubes and films can be produced particularly by a melt extrusion forming method.

The composition of the present disclosure can suitably be utilized also for tubes, bottles and the like.

So far, embodiments have been described, but it is to be understood that various changes and modifications of patterns and details may be made without departing from the subject matter and the scope of the claims.

<1> According to a first aspect of the present disclosure,
there is provided a composition comprising a polytetrafluoroethylene and a fluorine-containing copolymer,
wherein a content of the polytetrafluoroethylene in the composition is 0.03 to 0.30% by mass with respect to a mass of the composition;
the fluorine-containing copolymer comprises tetrafluoroethylene unit, hexafluoropropylene unit and perfluoro(propyl vinyl ether) unit;
a content of hexafluoropropylene unit in the fluorine-containing copolymer is 8.5 to 11.2% by mass with respect to the whole of the monomer units;
a content of perfluoro(propyl vinyl ether) unit in the fluorine-containing copolymer is 0.5 to 2.0% by mass with respect to the whole of the monomer units;
a melt flow rate at 372° C. of the fluorine-containing copolymer is 13.0 to 42.0 g/10 min.

<2> According to a second aspect of the present disclosure,
there is provided the composition according to the first aspect, wherein the content of hexafluoropropylene unit in the fluorine-containing copolymer is 9.4 to 11.0% by mass with respect to the whole of the monomer units.

<3> According to a third aspect of the present disclosure,
there is provided the composition according to the first or second aspect, wherein the content of perfluoro(propyl vinyl ether) unit in the fluorine-containing copolymer is 0.7 to 1.8% by mass with respect to the whole of the monomer units.

<4> According to a fourth aspect of the present disclosure,
there is provided the composition according to any one of the first to third aspects, wherein the melt flow rate at 372° C. of the fluorine-containing copolymer is 15.0 to 38.0 g/10 min.

<5> According to a fifth aspect of the present disclosure,
there is provided the composition according to any one of the first to fourth aspects, wherein a standard specific gravity of the polytetrafluoroethylene is 2.15 to 2.25.

<6> According to a sixth aspect of the present disclosure,
there is provided the composition according to any one of the first to fifth aspects, wherein the content of the polytetrafluoroethylene in the composition is 0.05 to 0.20% by mass with respect to the mass of the composition.

<7> According to a seventh aspect of the present disclosure, there is provided an injection molded article comprising the composition according to any one of the first to sixth aspects.

<8> According to an eighth aspect of the present disclosure, there is provided a powder coating material comprising the composition according to any one of the first to sixth aspects.

<9> According to a ninth aspect of the present disclosure, there is provided a coated electric wire comprising a coating layer comprising the composition according to any one of the first to sixth aspects.

### EXAMPLES

Then, the embodiments of the present disclosure will be described by way of Experimental Examples, but the present disclosure is not any more limited only to these Experimental Examples.

Each numerical value in Experimental Examples was measured by the following methods.

### (Content of Monomer Units)

The content of each monomer unit of the fluorine-containing copolymer was measured by an NMR analyzer (for example, manufactured by Bruker BioSpin GmbH, AVANCE 300, high-temperature probe), or an infrared absorption spectrometer (manufactured by PerkinElmer, Inc., Spectrum One).

### (Melt Flow Rate (MFR))

The MFR of the fluorine-containing copolymer was determined by using a Melt Indexer G-01 (manufactured by Toyo Seiki Seisaku-sho, Ltd.), and making the polymer to flow out from a die of 2 mm in inner diameter and 8 mm in length at 372° C. under a load of 5 kg and measuring the mass (g/10 min) of the polymer flowing out per 10 min, according to ASTM D1238.

### (The Number of —CF₂H)

The number of —CF₂H groups of the fluorine-containing copolymer was determined from a peak integrated value of the —CF₂H group acquired in a ¹⁹F-NMR measurement using a nuclear magnetic resonance spectrometer AVANCE-300 (manufactured by Bruker BioSpin GmbH) and set at a measurement temperature of (the melting point of the polymer+20° C.)

(The Numbers of —COOH, —COOCH₃, —CH₂OH, —COF, —CF═CF₂ and —CONH₂)

A dried powder or pellets obtained in each of Experimental Examples were molded by cold press to prepare a film of 0.25 to 0.3 mm in thickness. The film was 40 times scanned by a Fourier transform infrared spectrometer [FT-IR (Spectrum One, manufactured by PerkinElmer, Inc.)] and analyzed to obtain an infrared absorption spectrum. The obtained infrared absorption spectrum was compared with an infrared absorption spectrum of an already known film to determine the kinds of terminal groups. Further, from an absorption peak of a specific functional group emerging in a difference spectrum between the obtained infrared absorption spectrum and the infrared absorption spectrum of the already known film, the number N of the functional group per 1×10⁶ carbon atoms in the sample was calculated according to the following formula (A).

$$N = I \times K / t \qquad ( A )$$

I: absorbance
K: correction factor
t: thickness of film (mm)

Regarding the functional groups in Experimental Examples, for reference, the absorption frequency, the molar absorption coefficient and the correction factor are shown in Table 2. Further, the molar absorption coefficients are those determined from FT-IR measurement data of low molecular model compounds.

TABLE 2

| | | Molar | | |
|---|---|---|---|---|
| | Absorption | Extinction | | |
| Functional | Frequency | Coefficient | Correction | Model |
| Group | (cm⁻¹) | (l/cm/mol) | Factor | Compound |
| —COF | 1883 | 600 | 388 | C₇F₁₅COF |
| —COOH free | 1815 | 530 | 439 | H(CF₂)₆COOH |
| —COOH bonded | 1779 | 530 | 439 | H(CF₂)₆COOH |
| —COOCH₃ | 1795 | 680 | 342 | C₇F₁₅COOCH₃ |
| —CONH₂ | 3436 | 506 | 460 | C₇H₁₅CONH₂ |
| —CH₂OH₂, | 3648 | 104 | 2236 | C₇H₁₅CH₂OH |
| —OH | | | | |
| —CF═CF₂ | 1795 | 635 | 366 | CF₂═CF₂ |

### (The Number of —OC(═O)O—R (Carbonate Groups))

Analysis of the number of —OC(═O)O—R (carbonate groups) was carried out by a method described in International Publication No. WO2019/220850. The number of —OC(═O)O—R (carbonate groups) was calculated as in the calculation method of the number of functional groups, N, except for setting the absorption frequency at 1,817 cm⁻¹, the molar extinction coefficient at 170 (1/cm/mol) and the correction factor at 1,426.

### (Melting Point of the Fluorine-Containing Copolymer)

The fluorine-containing copolymer was heated, as a first temperature raising step at a temperature-increasing rate of 10° C./min from 200° C. to 350° C., then cooled at a cooling rate of 10° C./min from 350° C. to 200° C., and then again heated, as second temperature raising step, at a temperature-increasing rate of 10° C./min from 200° C. to 350° C. by using a differential scanning calorimeter (trade name: X-DSC7000, manufactured by Hitachi High-Tech Science Corp.); and the melting point of the fluorine-containing copolymer was determined from a melting curve peak observed in the second temperature raising step.

### (Standard Specific Gravity)

The standard specific gravity of the PTFE was measured by using a sample formed according to ASTM D4895-89 and by a water displacement method according to ASTM D792.

### (Melting Point of the PTFE)

By using a differential scanning calorimeter (trade name: X-DSC7000, manufactured by Hitachi High-Tech Science Corp.), the PTFE was heated, as first time temperature raising, at a temperature-increasing rate of 10° C./min from 230° C. to 380° C., then cooled at a cooling rate of 10° C./min from 380° C. to 230° C., and then again heated, as second time temperature raising, at a temperature-increasing rate of 10° C./min from 230° C. to 380° C.; and the melting point of the PTFE was determined from a melting curve peak observed in the second time temperature raising course.

### (Average Primary Particle Diameter)

The average primary particle diameter of the PTFE was determined by measuring a transmittance of projected light of 500 nm in wavelength for a unit length of an aqueous dispersion containing the PTFE so diluted with water so that the solid content became 0.22% by mass, and using a calibration curve of a PTFE number base average primary particle diameter previously obtained by measurement of the unidirectional particle diameters in a transmission electron microscopic photograph vs. the above transmittance.

In Experimental Examples 1 to 17, 20 and 21, the following aqueous dispersion of a PTFE was used.
An aqueous dispersion containing a PTFE
The PTFE: a TFE homopolymer having fibrillatability and non melt-processibility
The standard specific gravity of the PTFE: 2.173
The melting point of the PTFE: 327° C.
The average primary particle diameter of the PTFE: 300 nm
The solid content concentration: 30% by mass

### Experimental Example 1

An aqueous dispersion of a TFE/HFP/PPVE copolymer (FEP) of 20.5% by mass in solid content concentration was prepared according to the production method described in Japanese Patent Laid-Open No. 2010-235667 and by suitably adjusting the reaction scale, the reaction pressure, the amount of TFE to be charged, the amount of HFP to be charged, the amount of PPVE to be charged, the amount of ammonium persulfate to be charged, and the like.

To this FEP aqueous dispersion, the aqueous dispersion of the PTFE was added and mixed so that the ratio of the PTFE solid content to the solid content of the resultant aqueous dispersion became 0.50% by mass; thereafter, water and a 60% nitric acid were added and stirred to cause coagulation; after a solid phase and a liquid phase were separated, moisture was removed. The resultant was washed by using deionized water and an obtained white powder was dried at 200° C. for 60 hours to thereby obtain a powder.

### (Pelletization)

The obtained powder was melt extruded at 385° C. by a twin-screw extruder (KZW15TW-60MG-NH-700, manufactured by Thechnovel Corp.) to thereby obtain pellets. By using the obtained pellets, the content of each monomer unit of the FEP in the pellets was measured. The results are shown in Table 3.

### (Fluorination)

The obtained pellets were deaerated at 200° C. for 72 hours in an electric furnace, thereafter put in a vacuum vibration-type reactor VVD-30 (manufactured by Okawara Mfg. Co. Ltd.), and heated to 200° C. After vacuumizing, F₂ gas diluted to 20% by volume with N₂ gas was introduced to the atmospheric pressure. 0.5 hour after the F₂ gas introduction, vacuumizing was once carried out and F₂ gas was again introduced. Further, 0.5 hour thereafter, vacuumizing was again carried out and F₂ gas was again introduced. Thereafter, while the above operation of the F₂ gas introduction and the vacuumizing was carried out once every 1 hour, the reaction was carried out at a temperature of 200° C. for 8 hours. After the reaction was finished, the reactor interior was replaced sufficiently by N₂ gas to finish the fluorination reaction, whereby pellets were obtained. By using the obtained pellets, the MFR, the melting point and the number of functional groups of the FEP in the pellets were measured. The results are shown in Table 3.

### Experimental Example 2

An aqueous dispersion of a TFE/HFP/PPVE copolymer (FEP) of 20.5% by mass in solid content concentration was prepared according to the production method described in Japanese Patent Laid-Open No. 2010-235667 and by suitably adjusting the reaction scale, the reaction pressure, the amount of TFE to be charged, the amount of HFP to be charged, the amount of PPVE to be charged, the amount of ammonium persulfate to be charged, and the like.

To this FEP aqueous dispersion, the aqueous dispersion of the PTFE was added and mixed so that the ratio of the PTFE solid content to the solid content of the resultant aqueous dispersion became 0.06% by mass; thereafter, water and a 60% nitric acid were added and stirred to cause coagulation; after a solid phase and a liquid phase were separated, moisture was removed. The resultant was washed by using deionized water and an obtained white powder was dried at 200° C. for 60 hours to thereby obtain a powder.

### (Pelletization)

The obtained powder was melt extruded at 370° C. by a twin-screw extruder (KZW15TW-60MG-NH-700, manufactured by Technovel Corp.) to thereby obtain pellets of a fluororesin composition. By using the obtained pellets, the content of each monomer unit of the FEP in the pellets was measured. The results are shown in Table 3.

### (Fluorination)

The obtained pellets were fluorinated by the same method as in Experimental Example 1. By using the obtained pellets, the MFR, the melting point and the number of functional groups of the FEP in the pellets were measured. The results are shown in Table 3.

### Experimental Example 3

86 parts by mass of the pellets prepared in Experimental Example 2 and 14 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets having a content of the PTFE of 0.12% by mass. By using the obtained pellets, the content of each monomer unit, the MFR, the melting point and the number of functional groups of the FEP in the pellets were measured. The results are shown in Table 3.

### Experimental Example 4

An aqueous dispersion of a TFE/HFP/PPVE copolymer (FEP) of 20.5% by mass in solid content concentration was prepared according to the production method described in Japanese Patent Laid-Open No. 2010-235667 and by suitably adjusting the reaction scale, the reaction pressure, the amount of TFE to be charged, the amount of HFP to be charged, the amount of PPVE to be charged, the amount of ammonium persulfate to be charged, and the like.

To this FEP aqueous dispersion, the aqueous dispersion of the PTFE was added and mixed so that the ratio of the PTFE solid content to the solid content of the resultant aqueous dispersion became 0.07% by mass; thereafter, water and a 60% nitric acid were added and stirred to cause coagulation; after a solid phase and a liquid phase were separated, moisture was removed. The resultant was washed by using deionized water and an obtained white powder was dried at 200° C. for 60 hours to thereby obtain a powder.

### (Pelletization)

The obtained powder was formed into pellets (wet heat treatment) by the method described in Paragraph 0058 of Example 1 of International Publication No. WO2006/123694. By using the obtained pellets, the content of each monomer unit, the MFR, the melting point and the number of functional groups of the FEP in the pellets were measured. The results are shown in Table 3.

### Experimental Example 5

An aqueous dispersion of a copolymer (FEP) was prepared according to the production method described in Japanese Patent Laid-Open No. 2010-235667 and by suitably adjusting the reaction scale, the reaction pressure, the amount of TFE to be charged, the amount of HFP to be charged, the amount of PPVE to be charged, the amount of ammonium persulfate to be charged, and the like.

To this FEP aqueous dispersion, water and a 60% nitric acid were added and stirred to cause coagulation; after a solid phase and a liquid phase were separated, moisture was removed. The resultant was washed by using deionized water and an obtained white powder was dried at 200° C. for 60 hours to thereby obtain a powder.

### (Pelletization)

The obtained powder was extrusion pelletized by the method of Experimental Example 2. By using the obtained pellets, the content of each monomer unit of the FEP in the pellets was measured. The results are shown in Table 3.

### (Fluorination)

The obtained pellets were fluorinated by the same method as in Experimental Example 1. By using the obtained pellets, the MFR, the melting point and the number of functional groups of the FEP in the pellets were measured. The results are shown in Table 3.

### Experimental Example 6

An aqueous dispersion of a TFE/HFP/PPVE copolymer (FEP) of 20.5% by mass in solid content concentration was prepared according to the production method described in Japanese Patent Laid-Open No. 2010-235667 and by suitably adjusting the reaction scale, the reaction pressure, the amount of TFE to be charged, the amount of HFP to be charged, the amount of PPVE to be charged, the amount of ammonium persulfate to be charged, and the like.

To this FEP aqueous dispersion, the aqueous dispersion of the PTFE was added and mixed so that the ratio of the PTFE solid content to the solid content of the resultant aqueous dispersion became 0.07% by mass; thereafter, water and a 60% nitric acid were added and stirred to cause coagulation; after a solid phase and a liquid phase were separated, moisture was removed. The resultant was washed by using deionized water and an obtained white powder was dried at 200° C. for 60 hours to thereby obtain a powder.

### (Pelletization)

The obtained powder was extrusion pelletized by the method of Experimental Example 2. By using the obtained pellets, the content of each monomer unit of the FEP in the pellets was measured. The results are shown in Table 3.

### (Fluorination)

The obtained pellets were fluorinated by the same method as in Experimental Example 1. By using the obtained pellets, the MFR, the melting point and the number of functional groups of the FEP in the pellets were measured. The results are shown in Table 3.

### Experimental Example 7

82 parts by mass of pellets of a fluorinated TFE/HFP/PPVE copolymer (FEP) and 18 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets of a fluororesin composition having a content of the PTFE of 0.09% by mass. By using the obtained pellets, the content of each monomer unit, the MFR, the melting point and the number of functional groups of the FEP in the pellets were measured. The results are shown in Table 3.

### Experimental Example 8

Pellets were obtained by the method of Example 1 of International Publication No. WO2009/044753. By using the obtained pellets, the content of each monomer unit, the MFR, the melting point and the number of functional groups of the FEP in the pellets were measured. The results are shown in Table 3.

### Experimental Example 9

Pellets were obtained by the method of Example 1 of International Publication No. WO2006/123694. By using the obtained pellets, the content of each monomer unit, the MFR, the melting point and the number of functional groups of the FEP in the pellets were measured. The results are shown in Table 3.

### Experimental Example 10

86 parts by mass of pellets of a fluorinated TFE/HFP/PPVE copolymer (FEP) and 14 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets of a fluororesin composition having a content of the PTFE of 0.07% by mass. By using the obtained pellets, the content of each monomer unit, the MFR, the melting point and the number of functional groups of the FEP in the pellets were measured. The results are shown in Table 3.

### Experimental Example 11

86 parts by mass of pellets of a fluorinated TFE/HFP/PPVE copolymer (FEP) and 14 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets of a fluororesin composition having a content of the PTFE of 0.07% by mass. By using the obtained pellets, the content of each monomer unit, the MFR, the melting point and the number of functional groups of the FEP in the pellets were measured. The results are shown in Table 3.

### Experimental Example 12

86 parts by mass of pellets of a fluorinated TFE/HFP/PPVE copolymer (FEP) and 14 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets of a fluororesin composition having a content of the PTFE of 0.07% by mass. By using the obtained pellets, the content of each monomer unit, the MFR, the melting point and the number of functional groups of the FEP in the pellets were measured. The results are shown in Table 3.

### Experimental Example 13

86 parts by mass of pellets of a fluorinated TFE/HFP/PPVE copolymer (FEP) and 14 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets of a fluororesin composition having a content of the PTFE of 0.07% by mass. By using the obtained pellets, the content of each monomer unit, the MFR, the melting point and the number of functional groups of the FEP in the pellets were measured. The results are shown in Table 3.

### Experimental Example 14

86 parts by mass of pellets of a fluorinated TFE/HFP/PPVE copolymer (FEP) and 14 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets of a fluororesin composition having a content of the PTFE of 0.07% by mass. By using the obtained pellets, the content of each monomer unit, the MFR, the melting point and the number of functional groups of the FEP in the pellets were measured. The results are shown in Table 3.

### Experimental Example 15

86 parts by mass of pellets of a fluorinated TFE/HFP/PPVE copolymer (FEP) and 14 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets of a fluororesin composition having a content of the PTFE of 0.07% by mass. By using the obtained pellets, the content of each monomer unit, the MFR, the melting point and the number of functional groups of the FEP in the pellets were measured. The results are shown in Table 3.

### Experimental Example 16

86 parts by mass of pellets of a fluorinated TFE/HFP/PPVE copolymer (FEP) and 14 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets of a fluororesin composition having a content of the PTFE of 0.07% by mass. By using the obtained pellets, the content of each monomer unit, the MFR, the melting point and the number of functional groups of the FEP in the pellets were measured. The results are shown in Table 3.

### Experimental Example 17

90 parts by mass of pellets of a fluorinated TFE/HFP/PPVE copolymer (FEP) and 10 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets of a fluororesin composition having a content of the PTFE of 0.05% by mass. By using the obtained pellets, the content of each monomer unit, the MFR, the melting point and the number of functional groups of the FEP in the pellets were measured. The results are shown in Table 3.

### Experimental Example 18

In Experimental Example 18, a PTFE aqueous dispersion 2 was used.
A PTFE aqueous dispersion 2
The PTFE: a TFE homopolymer having fibrillatability and non melt-processibility
The standard specific gravity of the PTFE: 2.200
The melting point of the PTFE: 327° C.
The average primary particle diameter of the PTFE: 300 nm
The solid content concentration: 30% by mass

An aqueous dispersion of a TFE/HFP/PPVE copolymer (FEP) of 20.5% by mass in solid content concentration was prepared according to the production method described in Japanese Patent Laid-Open No. 2010-235667 and by suitably adjusting the reaction scale, the reaction pressure, the amount of TFE to be charged, the amount of HFP to be charged, the amount of PPVE to be charged, the amount of ammonium persulfate to be charged, and the like.

To this FEP aqueous dispersion, the PTFE aqueous dispersion 2 was added and mixed so that the ratio of the PTFE solid content to the solid content of the resultant aqueous dispersion became 0.20% by mass; thereafter, water and a 60% nitric acid were added and stirred to cause coagulation; after a solid phase and a liquid phase were separated, moisture was removed. The resultant was washed by using deionized water and an obtained white powder was dried at 200° C. for 60 hours to thereby obtain a powder.

### (Pelletization)

The obtained powder was melt extruded at 375° C. by a twin-screw extruder (KZW15TW-60MG-NH-700, manufactured by Technovel Corp.) to thereby obtain pellets of a fluororesin composition. By using the obtained pellets, the content of each monomer unit of the FEP in the pellets was measured. The results are shown in Table 3.

### (Fluorination)

The obtained pellets were fluorinated by the same method as in Experimental Example 1. By using the obtained pellets, the MFR, the melting point and the number of functional groups of the FEP in the pellets were measured. The results are shown in Table 3.

### Experimental Example 19

In Experimental Example 19, a PTFE aqueous dispersion 3 was used.
A PTFE aqueous dispersion 3
The PTFE: a TFE homopolymer having fibrillatability and non melt-processibility, and containing 0.1% by mass of PPVE (modified PTFE)
The standard specific gravity of the PTFE: 2.159
The melting point of the PTFE: 324° C.
The average primary particle diameter of the PTFE: 300 nm
The solid content concentration: 30% by mass

An aqueous dispersion of a TFE/HFP/PPVE copolymer (FEP) of 20.5% by mass in solid content concentration was prepared according to the production method described in Japanese Patent Laid-Open No. 2010-235667 and by suitably adjusting the reaction scale, the reaction pressure, the amount of TFE to be charged, the amount of HFP to be charged, the amount of PPVE to be charged, the amount of ammonium persulfate to be charged, and the like.

To this FEP aqueous dispersion, the PTFE aqueous dispersion 3 was added and mixed so that the ratio of the PTFE solid content to the solid content of the resultant aqueous dispersion became 0.15% by mass; thereafter, water and a 60% nitric acid were added and stirred to cause coagulation; after a solid phase and a liquid phase were separated, moisture was removed. The resultant was washed by using deionized water and an obtained white powder was dried at 200° C. for 60 hours to thereby obtain a powder.

### (Pelletization)

The obtained powder was melt extruded at 375° C. by a twin-screw extruder (KZW15TW-60MG-NH-700, manufactured by Technovel Corp.) to thereby obtain pellets of a fluororesin composition. By using the obtained pellets, the content of each monomer unit of the FEP in the pellets was measured. The results are shown in Table 3.

### (Fluorination)

The obtained pellets were deaerated at 200° C. for 72 hours in an electric furnace, thereafter put in a vacuum vibration-type reactor VVD-30 (manufactured by Okawara Mfg. Co. Ltd.), and heated to 170° C. After vacuumizing, F₂ gas diluted to 20% by volume with N₂ gas was introduced to the atmospheric pressure. 0.5 hour after the F₂ gas introduction, vacuumizing was once carried out and F₂ gas was again introduced. Further, 0.5 hour thereafter, vacuumizing was again carried out and F₂ gas was again introduced. Thereafter, while the above operation of the F₂ gas introduction and the vacuumizing was carried out once every 1 hour, the reaction was carried out at a temperature of 170° C. for 6 hours. After the reaction was finished, the reactor interior was replaced sufficiently by N₂ gas to finish the fluorination reaction, thereby obtaining pellets. By using the obtained pellets, the MFR, the melting point and the number of functional groups of the FEP in the pellets were measured. The results are shown in Table 3.

### Experimental Example 20

90 parts by mass of pellets of a fluorinated TFE/HFP/PPVE copolymer (FEP) and 10 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets of a fluororesin composition having a content of the PTFE of 0.05% by mass. By using the obtained pellets, the content of each monomer unit, the MFR, the melting point and the number of functional groups of the FEP in the pellets were measured. The results are shown in Table 3.

### Experimental Example 21

90 parts by mass of pellets of a fluorinated TFE/HFP/PPVE copolymer (FEP) and 10 parts by mass of the pellets prepared in Experimental Example 1 were mixed, and thereafter melt extruded at 345° C. by a twin-screw extruder (Labo Plastomill 30C-150, manufactured by Toyo Seiki Seisaku-sho Ltd.) to thereby obtain pellets of a fluororesin composition having a content of the PTFE of 0.05% by mass. By using the obtained pellets, the content of each monomer unit, the MFR, the melting point and the number of functional groups of the FEP in the pellets were measured. The results are shown in Table 3.

Then, Reference Examples of the production method of copolymers will be described. The copolymers described in Reference Examples were not included in the embodiments of the composition of the present disclosure.

### Reference Example 1

40.25 kg of deionized water and 0.099 kg of methanol were fed in a 174 L-volume autoclave with a stirrer, and the autoclave inside was sufficiently vacuumized and replaced with nitrogen. Thereafter, the autoclave inside was vacuum deaerated, and in the autoclave put in a vacuum state, 40.25 kg of HFP and 0.36 kg of PPVE were fed; and the autoclave was heated to 30.0° C. Then, TFE was fed until the internal pressure of the autoclave became 0.905 MPa; and then, 0.63 kg of an 8-mass % di(ω-hydroperfluorohexanoyl) peroxide solution (hereinafter, abbreviated to DHP) was fed in the autoclave to initiate polymerization. The internal pressure of the autoclave at the initiation of the polymerization was set at 0.905 MPa, and by continuously adding TFE, the set pressure was made to be held. After 1.5 hours from the polymerization initiation, 0.099 kg of methanol was additionally fed. After 2 hours and 4 hours from the polymerization initiation, 0.63 kg of DHP was additionally fed, and the internal pressure was lowered by 0.001 MPa, respectively; after 6 hours therefrom, 0.48 kg thereof was fed and the internal pressure was lowered by 0.001 MPa. Hereafter, 0.13 kg of DHP was fed at every 2 hours until the reaction finished, and at every time, the internal pressure was lowered by 0.001 MPa.

Then, at each time point when the amount of TFE continuously additionally fed reached 8.1 kg, 16.2 kg and 24.3 kg, 0.11 kg of PPVE was additionally fed. Then, at each time point when the amount of TFE additionally fed reached 6.0 kg and 18.1 kg, 0.099 kg of methanol was additionally fed in the autoclave. Then, when the amount of TFE additionally fed reached 40.25 kg, the polymerization was made to finish. After the finish of the polymerization, unreacted TFE and HFP were discharged to thereby obtain a wet powder. Then, the wet powder was washed with pure water, and thereafter dried at 150° C. for 10 hours to thereby obtain 46.2 kg of a dry powder.

The obtained powder was melt extruded at 370° C. by a screw extruder (trade name: PCM46, manufactured by Ikegai Corp.) to thereby obtain pellets of a copolymer. By using the obtained pellets, the above physical properties were measured by the methods described above. The results are shown in Table 3.

### Reference Example 2

Copolymer pellets were obtained as in Reference Example 1, except for changing the amount of methanol fed before the polymerization initiation to 0.067 kg, changing the each amount of methanol dividedly additionally fed after the polymerization initiation to 0.067 kg, changing the amount of PPVE fed before the polymerization initiation to 0.36 kg, changing the each amount of PPVE dividedly additionally fed after the polymerization initiation to 0.11 kg, and changing the each set pressure in the autoclave inside before and after the polymerization initiation to 0.906 MPa. By using obtained pellets, the above physical properties were measured by the methods described above. The results are shown in Table 3.

### Reference Example 3

40.25 kg of deionized water and 0.195 kg of methanol were fed in a 174 L-volume autoclave with a stirrer, and the autoclave inside was sufficiently vacuumized and replaced with nitrogen. Thereafter, the autoclave inside was vacuum deaerated, and in the autoclave put in a vacuum state, 40.25 kg of HFP was fed; and the autoclave was heated to 30.0° C. Then, TFE was fed until the internal pressure of the autoclave became 0.926 MPa; and then, 0.63 kg of an 8-mass % di(ω-hydroperfluorohexanoyl) peroxide solution (hereinafter, abbreviated to DHP) was fed in the autoclave to initiate polymerization. The internal pressure of the autoclave at the initiation of the polymerization was set at 0.926 MPa, and by continuously adding TFE, the set pressure was made to be held. After 1.5 hours from the polymerization initiation, 0.195 kg of methanol was additionally fed. After 2 hours and 4 hours from the polymerization initiation, 0.63 kg of DHP was additionally fed, and the internal pressure was lowered by 0.001 MPa, respectively; after 6 hours therefrom, 0.48 kg thereof was fed and the internal pressure was lowered by 0.001 MPa. Hereafter, 0.13 kg of DHP was additionally fed at every 2 hours until the reaction finished, and at the every time, the internal pressure was lowered by 0.001 MPa.

Then, at each time point when the amount of TFE additionally fed reached 6.0 kg and 18.1 kg, 0.195 kg of methanol was additionally fed in the autoclave. Then, when the amount of TFE additionally fed reached 40.25 kg, the polymerization was made to finish. After the finish of the polymerization, unreacted TFE and HFP were discharged to thereby obtain a wet powder. Then, the wet powder was washed with pure water, and thereafter dried at 150° C. for 10 hours to thereby obtain 45.2 kg of a dry powder.

The obtained powder was melt extruded at 370° C. by a screw extruder (trade name: PCM46, manufactured by Ikegai Corp.) to thereby obtain pellets of a copolymer. By using the obtained pellets, the HFP content and the PPVE content were measured by the methods described above. The results are shown in Table 3.

### Reference Example 4

Copolymer pellets were obtained as in Reference Example 1, except for changing the amount of methanol fed before the polymerization initiation to 0.274 kg, changing the each amount of methanol dividedly additionally fed after the polymerization initiation to 0.274 kg, changing the amount of PPVE fed before the polymerization initiation to 0.41 kg, changing the each amount of PPVE dividedly additionally fed after the polymerization initiation to 0.11 kg, and changing the each set pressure in the autoclave inside before and after the polymerization initiation to 0.937 MPa. By using obtained pellets, the above physical properties were measured by the methods described above. The results are shown in Table 3.

### Reference Example 5

40.25 kg of deionized water and 0.189 kg of methanol were fed in a 174 L-volume autoclave with a stirrer, and the autoclave inside was sufficiently vacuumized and replaced with nitrogen. Thereafter, the autoclave inside was vacuum deaerated, and in the autoclave put in a vacuum state, 40.25 kg of HFP and 0.42 kg of PPVE were fed; and the autoclave was heated to 25.5° C. Then, TFE was fed until the internal pressure of the autoclave became 0.830 MPa; and then, 1.25 kg of an 8-mass % di(ω-hydroperfluorohexanoyl) peroxide solution (hereinafter, abbreviated to DHP) was fed in the autoclave to initiate polymerization. The internal pressure of the autoclave at the initiation of the polymerization was set at 0.830 MPa, and by continuously adding TFE, the set pressure was made to be held. After 1.5 hours from the polymerization initiation, 0.189 kg of methanol was additionally fed. After 2 hours and after 4 hours from the polymerization initiation, 1.25 kg of DHP was additionally fed, and the internal pressure was lowered by 0.002 MPa, respectively; after 6 hours therefrom, 0.96 kg thereof was fed and the internal pressure was lowered by 0.002 MPa. Hereafter, 0.25 kg of DHP was fed at every 2 hours until the reaction finished, and at the every time, the internal pressure was lowered by 0.002 MPa.

Then, at each time point when the amount of TFE continuously additionally fed reached 8.1 kg, 16.2 kg and 24.3 kg, 0.11 kg of PPVE was additionally fed. Then, at each time point when the amount of TFE additionally fed reached 6.0 kg and 18.1 kg, 0.189 kg of methanol was additionally fed in the autoclave. Then, when the amount of TFE additionally fed reached 40.25 kg, the polymerization was made to finish. After the finish of the polymerization, unreacted TFE and HFP were discharged to thereby obtain a wet powder. Then, the wet powder was washed with pure water, and thereafter dried at 150° C. for 10 hours to thereby obtain 45.4 kg of a dry powder.

The obtained powder was melt extruded at 370° C. by a screw extruder (trade name: PCM46, manufactured by Ikegai Corp.) to thereby obtain pellets of a copolymer. By using the obtained pellets, the above physical properties were measured by the methods described above. The results are shown in Table 3.

### Reference Example 6

Copolymer pellets were obtained as in Reference Example 5, except for changing the amount of methanol fed before the polymerization initiation to 0.128 kg, changing the each amount of methanol dividedly additionally fed after the polymerization initiation to 0.128 kg, changing the amount of PPVE fed before the polymerization initiation to 0.46 kg, changing the each amount of PPVE dividedly additionally fed after the polymerization initiation to 0.12 kg, and changing the each set pressure in the autoclave inside before and after the polymerization initiation to 0.832 MPa. By using the obtained pellets, the above physical properties were measured by the methods described above. The results are shown in Table 3.

### Reference Example 7

Copolymer pellets were obtained as in Reference Example 1, except for changing the amount of methanol fed before the polymerization initiation to 0.206 kg, changing the each amount of methanol dividedly additionally fed after the polymerization initiation to 0.206 kg, changing the amount of PPVE fed before the polymerization initiation to 0.35 kg, changing the each amount of PPVE dividedly additionally fed after the polymerization initiation to 0.11 kg, and changing the each set pressure in the autoclave inside before and after the polymerization initiation to 0.897 MPa. By using obtained pellets, the above physical properties were measured by the methods described above. The results are shown in Table 3.

TABLE 3

| | | Fluorine-containing copolymer | | | | | | | |
|---|---|---|---|---|---|---|---|---|---|
| | | | | | | —COOH | | | |
| | PTFE | HFP | PPVE | | | —COF | | | |
| | content | content | content | | —CF₂H | —CH₂OH | —OCOOR | Others | Melting |
| | (% by | (% by | (% by | MFR | (number/ | (number/ | (number/ | (number/ | point |
| | mass) | mass) | mass) | (g/10 min) | C10⁶ [symbol] ) | C10⁶) | C10⁶) | C10⁶) | (° C.) |
| Experimental | 0.07 | 11.5 | 0.9 | 35.7 | <9 | <6 | ND | <6 | 257 |
| Example 8 | | | | | | | | | |
| Experimental | 0.07 | 11.7 | 1.0 | 25.9 | 478 | 26 | ND | <6 | 257 |
| Example 9 | | | | | | | | | |
| Experimental | 0.50 | 10.8 | 1.0 | 28.0 | <9 | <6 | ND | <6 | 259 |
| Example 1 | | | | | | | | | |
| Experimental | 0 | 10.8 | 1.0 | 28.0 | <9 | <6 | ND | <6 | 259 |
| Example 5 | | | | | | | | | |
| Experimental | 0.07 | 6.0 | 1.0 | 29.0 | <9 | <6 | ND | <6 | 285 |
| Example 10 | | | | | | | | | |
| Experimental | 0.07 | 10.8 | 1.0 | 60.0 | <9 | <6 | ND | <6 | 260 |
| Example 11 | | | | | | | | | |
| Experimental | 0.07 | 10.8 | 1.2 | 7.0 | <9 | <6 | ND | <6 | 256 |
| Example 12 | | | | | | | | | |
| Experimental | 0.07 | 11.0 | 0.1 | 23.0 | <9 | <6 | ND | <6 | 263 |
| Example 13 | | | | | | | | | |
| Experimental | 0.07 | 11.0 | 3.2 | 30.0 | <9 | <6 | ND | <6 | 237 |
| Example 14 | | | | | | | | | |
| Experimental | 0.06 | 10.8 | 1.0 | 28.0 | <9 | <6 | ND | <6 | 259 |
| Example 2 | | | | | | | | | |
| Experimental | 0.12 | 10.8 | 1.0 | 28.0 | <9 | <6 | ND | <6 | 259 |
| Example 3 | | | | | | | | | |
| Experimental | 0.07 | 10.8 | 1.0 | 26.0 | 479 | 25 | ND | <6 | 259 |
| Example 4 | | | | | | | | | |
| Experimental | 0.07 | 10.7 | 1.3 | 36.5 | <9 | <6 | ND | <6 | 258 |
| Example 6 | | | | | | | | | |
| Experimental | 0.09 | 11.0 | 0.7 | 23.0 | <9 | <6 | ND | <6 | 259 |
| Example 7 | | | | | | | | | |
| Experimental | 0.07 | 10.8 | 1.0 | 15.0 | <9 | <6 | ND | <6 | 257 |
| Example 12 | | | | | | | | | |
| Experimental | 0.07 | 10.6 | 1.2 | 19.0 | <9 | 10 | ND | <6 | 257 |
| Example 16 | | | | | | | | | |
| Experimental | 0.05 | 9.7 | 1.6 | 33.0 | <9 | <6 | ND | <6 | 260 |
| Example 17 | | | | | | | | | |
| Experimental | 0.20 | 10.8 | 1.0 | 31.0 | <9 | <6 | ND | <6 | 260 |
| Example 18 | | | | | | | | | |
| Experimental | 0.15 | 10.8 | 1.0 | 34.0 | <9 | 50 | ND | <6 | 260 |
| Example 19 | | | | | | | | | |
| Experimental | 0.05 | 9.5 | 1.8 | 38.0 | <9 | <6 | ND | <6 | 261 |
| Example 20 | | | | | | | | | |
| Experimental | 0.05 | 10.1 | 1.3 | 25.0 | <9 | <6 | ND | <6 | 259 |
| Example 21 | | | | | | | | | |
| Reference | 0 | 11.1 | 1.0 | 3.9 | 244 | 25 | ND | <6 | 254 |
| Example 1 | | | | | | | | | |
| Reference | 0 | 11.0 | 1.0 | 2.8 | 203 | 25 | ND | <6 | 255 |
| Example 2 | | | | | | | | | |
| Reference | 0 | 10.1 | 0.0 | 3.0 | 223 | 14 | ND | <6 | 268 |
| Example 3 | | | | | | | | | |
| Reference | 0 | 9.6 | 1.0 | 7.0 | 318 | 24 | ND | <6 | 264 |
| Example 4 | | | | | | | | | |
| Reference | 0 | 9.5 | 1.0 | 5.4 | 286 | 24 | ND | <6 | 265 |
| Example 5 | | | | | | | | | |
| Reference | 0 | 9.4 | 1.1 | 3.2 | 221 | 24 | ND | <6 | 264 |
| Example 6 | | | | | | | | | |
| Reference | 0 | 11.5 | 1.0 | 12.0 | 383 | 25 | ND | <6 | 255 |
| Example 7 | | | | | | | | | |

[symbol]

indicates data missing or illegible when filed

The description of “Others (number/C10⁶)” in Table 3 denotes the total number of —COOCH₃, —CF═CF₂ and —CONH₂. The description of “<9” in Table 3 means that the number (total number) of —CF₂H groups was less than 9. The description of “<6” in Table 3 means that the number (total number) of the objective functional groups was less than 6. The description of “ND” in Table 3 means that for the objective functional group, no quantitatively determinable peak could be observed.

Then, by using the obtained pellets, the following properties were evaluated. The results are shown in Table 4.

### 1. Production of Flat Boards

Pellets were injection molded by using an injection molding machine (SE50EV-A, manufactured by Sumitomo Heavy Industries, Ltd.) set at a cylinder temperature of 380° C., a mold temperature of 170° C. and an injection rate of 5 mm/s. The mold used was an HPM38-made mold (100 mm×100 mm×2.0 mmt, side gate). When the injection molded article was removed, it was caused to drop down from the mold by ejection by an ejector pin and the injection molded article was recovered by using a chute right under the mold.

### 1-1. Flow Marks

The injection molded article was visually checked and evaluated under the following criteria.

Good: no flow marks were observed.

Poor: flow marks were observed.

### 1-2. Streaks

10 injection molded articles were observed and the presence/absence of fibrous streaks was checked. The fibrous streaks are caused by cobwebbing (molding defects) generated in molding.

Good: no fibrous streaks were observed on all of the 10 injection molded articles.

Poor: fibrous streaks were observed on one or more injection molded articles.

### 1-3. Scratches

The injection molded article right after the recovery thereof from the chute was visually observed and evaluated under the following criteria.

Good: no scratches by scrubbing were observed.

Poor: scratches by scrubbing were observed.

### 1-4. Delamination

The injection molded article was observed and the delamination was visually evaluated under the following criteria.

Good: no roughness by surface layer delamination was observed on the surface.

Poor: roughness by surface layer delamination was observed on the surface.

### 1-5. Mold Releasability

Molding was carried out 10 times continuously and the number of times dropping of the injection molded articles from the mold by ejection by the ejector pin did not occur was checked.

Good: 0 times

Poor: 1 to 10 times

### 3. Evaluation of the 113° C. Load Deformation

By using the pellets, a sheet of 0.5 mm in thickness was prepared by heat press, and a sample of 2.0 mm in width and 20 mm in length was prepared from the obtained sheet. The prepared sample was mounted on measurement jigs so that the distance between the jigs became approximately 10 mm; and by using a TMA-7100, manufactured by Hitachi High-Tech Science Corp., the sample was heated to 113° C. and then a load of 4.37 N/mm² was applied on the sample, which was then allowed to stand as it was for 900 min.

The difference between a proportion (%) obtained by dividing a sample length at the timepoint of 80 min from the start of the loading by an initial sample length and a proportion (%) obtained by dividing a sample length at the timepoint of 855 min from the start of the loading by the initial sample length was calculated as a deformation rate (%).

The deformation rate (%) was a value indicating how much deformation occurred in from the 80-min timepoint to the 855-min timepoint, and a sample low in the deformation rate (%) is hardly deformed even when being loaded with a load in a high-temperature environment.

$$Deformation rate ( \% ) = {X}_{2} / {X}_{0} \times 100 - {X}_{1} / {X}_{0} \times 100$$

X₀: the initial sample length
X₁: the sample length (mm) at the timepoint of 80 min from the start of the loading
X₂: the sample length (mm) at the timepoint of 855 min from the start of the loading

### 4. Stress Crack Resistance at a High Temperature

By using the pellets and a heat press molding machine, a formed article of approximately 2 mm in thickness was prepared. The obtained sheet was punched out by using a rectangular dumbbell of 13.5 mm×38 mm to obtain three test pieces. A notch was formed on the middle of a long side of the each obtained test piece according to ASTM D1693 by a blade of 19 mm×0.45 mm. The three notched test pieces and 25 g of a 3 mass %-hydrogen peroxide aqueous solution were put in a 100-mL polypropylene-made bottle, and heated in an electric furnace at 80° C. for 20 hours; thereafter, the notched test pieces were taken out. The obtained three notched test pieces were mounted on a stress crack test jig according to ASTM D1693, and heated in an electric furnace at 80° C. for 2 hours; thereafter, the notches and their vicinities were visually observed and the number of cracks was counted. A sheet having no crack generated even when being immersed in the chemical solution at the high temperature is excellent in the stress crack resistance at high temperatures.

Good: the number of cracks was 0.

Poor: the number of cracks was 1 or more.

### 5. Tensile Elastic Modulus

By using the pellets and a heat press molding machine, a test piece (compression molded) of 2.0 mm in thickness was prepared. A dumbbell shape test piece was punched out from the test piece by using an ASTM V-type dumbbell; and by using the obtained dumbbell shape test piece, the tensile elastic modulus was measured at 105° C. by using an Autograph (AG-I, 300 kN, manufactured by Shimadzu Corp.), according to ASTM D638 under the condition of 50 mm/min. A sheet high in the tensile elastic modulus is excellent in the deformation resistance to tensile stress.

### 6. Tensile Strength at the Timepoint of 320,000 Cycles

By using the pellets and a heat press molding machine, a sheet of approximately 2.4 mm in thickness was prepared, and a sample in a dumbbell shape (thickness: 2.4 mm, width: 5.0 mm, measuring section length: 22 mm) was prepared by using an ASTM D1708 microdumbbell. By using a fatigue testing machine MMT-250NV-10, manufactured by Shimadzu Corp., the sample was mounted on measuring jigs and the measuring jigs in a state of the sample being mounted were installed in a thermostatic chamber at 110° C. The tensile operation in the uniaxial direction was repeated at a stroke of 0.2 mm and at a frequency of 100 Hz, and the tensile strength (tensile strength at the time the stroke was +0.2 mm, unit: N) at the timepoint of 320,000 cycles was measured.

### 7. Preparation and Evaluation of a Powder Coating Material

The obtained pellets were crushed and then sieved through a No. 18 sieve (manufactured by Tokyo Screen Co. Ltd.) to thereby obtain a copolymer powder. The copolymer powder was degreased and applied on a smooth-surface SUS316 substrate (200 mm×200 mm×5 mm) by an electrostatic coating method; thereafter, the resultant was vertically suspended in a drying oven and fired at 285° C. for 30 min to thereby obtain a coating film of approximately 100 μm in film thickness. The obtained coating film was visually observed and the prepared state of the coating film was evaluated. Then, the SUS316 substrate together with the coating film was dipped in water and heated at 95° C. for 20 hours; and the coating film having peeled off from the SUS316 substrate was recovered and it was confirmed that the coating film was prepared in the film thickness within 100 μm±20%.

The obtained coating film was evaluated according to the following criteria.

Good: a good coating film could be prepared.

Poor: a good coating film could not be prepared.
Experimental Example 1: a smooth-surface coating film could not be prepared.
Experimental Example 10: melting was incomplete and a coating film could not be prepared.
   Experimental Example 11: a coating film having a target film thickness could not be prepared due to sagging.
Experimental Example 12: a smooth-surface coating film could not be prepared.

### 8. Preparation and Evaluation of a Coated Electric Wire (Electric Wire Coating Condition)

By using a 30-mmϕ electric wire coating forming machine (manufactured by Tanabe Plastics Machinery Co. Ltd.), extrusion coating was carried out in the following coating thickness on a conductor of 0.50 mm in conductor diameter to thereby obtain a coated electric wire. The electric wire coating extrusion conditions were as follows.
a) Core conductor: mild steel wire conductor diameter: 0.50 mm
b) Coating thickness: 0.15 mm
c) Coated electric wire diameter: 0.80 mm
d) Electric wire take-over speed: 100 m/min
e) Extrusion condition:

$$Cylinder screw diameter = 30 mm , a single - screw extruder of L / D = 22 \\ Die ( inner diameter ) / tip ( outer diameter ) = 9. mm / 5. mm$$

Set temperature of the extruder: barrel section C-1 (320° C.), barrel section C-2 (350° C.), barrel section C-3 (375° C.), head section H (390° C.), die section D-1 (390° C.), die section D-2 (390° C.), Set temperature for preheating core wire: 80° C.

The result of the electric wire coating formation was evaluated under the following criteria.

Good: a coated electric wire could be prepared.

Poor: a coated electric wire could not be prepared.
Experimental Example 1: the preparation was unacceptable due to a large dispersion in the outer diameter.
Experimental Example 10: the preparation was unacceptable due to coating film discontinuity.
Experimental Example 11: the preparation was unacceptable due to a large dispersion in the outer diameter.
Experimental Example 12: the preparation was unacceptable due to coating film discontinuity.
Experimental Example 13: the preparation was unacceptable due to coating film discontinuity.

### (Check of the Outer Diameter)

The outer diameter of the coated electric wire was measured continuously for 10 min by using an outer diameter measuring device (ODAX18XY, manufactured by Zumbach Electronic AG), and the case where outer diameter values obtained by rounding the maximum and minimum values in the measured outer diameters to two decimal places deviated by 3% or more from a target outer diameter of 0.90 mm was determined as unacceptable.

### Evaluation of the 110° C. Load Deformation of the Electric Wire Coating

The coating layer of the coated electric wire obtained in the above was peeled off, and a sample of approximately 2 mm in width and 22 mm in length was prepared from the obtained coating layer. The prepared sample was mounted on measurement jigs so that the distance between the jigs became approximately 10 mm; and by using a TMA-7100, manufactured by Hitachi High-Tech Science Corp., the sample was heated to 110° C. and then a load of 4.49 N/mm² was applied on the sample, which was then allowed to stand as it was for 900 min.

The difference between a proportion (%) obtained by dividing a sample length at the timepoint of 85 min from the start of the loading by an initial sample length and a proportion (%) obtained by dividing a sample length at the timepoint of 900 min from the start of the loading by the initial sample length was calculated as a deformation rate (%).

The deformation rate (%) was a value indicating how much deformation occurred in from the 85-min timepoint to the 900-min timepoint. A sample low in the deformation rate (%) is hardly deformed even when being loaded with a load in a high-temperature environment.

$$Deformation rate ( \% ) = {X}_{2} / {X}_{0} \times 100 - {X}_{1} / {X}_{0} \times 100$$

X₀: the initial sample length
X₁: the sample length (mm) at the timepoint of 85 min from the start of the loading
X₂: the sample length (mm) at the timepoint of 900 min from the start of the loading

### [Table 4]

| | | | | | | | | | Tensile | | | 110° C. |
|---|---|---|---|---|---|---|---|---|---|---|---|---|
| | | | | | | | | | trength | | | Load |
| | | | | | | 113° C. | | 105° C. | at the | | | deformation |
| | | | | | | Load | | Tensile | timepoint | Evaluation | Evaluation | (electric |
| | | | | | Mold | deformation | Stress | elastic | of 320,000 | of coating | of electric | wire |
| | Flow | | | Delam- | releas- | (sheet) | crack | modulus | cycles | film | wire | coating) |
| | mark | Streak | Scratch | ination | ability | % | resistance | MPa | N | formation | coating | % |
| Experimental | good | good | good | good | poor | 4.91 | good | 51.0 | 4.71 | good | good | 4.85 |
| Example 8 | | | | | | | | | | | | |
| Experimental | good | good | good | good | poor | 5.32 | good | 50.3 | 4.54 | good | good | 5.25 |
| Example 9 | | | | | | | | | | | | |
| Experimental | good | poor | good | good | good | 3.06 | poor | 58.7 | 6.99 | poor | poor | — |
| Example 1 | | | | | | | | | | | | |
| Experimental | good | good | good | poor | good | 4.70 | good | 57.2 | 4.89 | good | good | 4.60 |
| Example 5 | | | | | | | | | | | | |
| Experimental | good | good | poor | good | good | 0.86 | poor | 89.1 | 9.63 | poor | poor | — |
| Example 10 | | | | | | | | | | | | |
| Experimental | good | poor | good | good | good | 4.00 | poor | 63.9 | 6.35 | poor | poor | — |
| Example 11 | | | | | | | | | | | | |
| Experimental | poor | good | good | poor | good | 3.55 | good | 39.9 | 6.89 | poor | poor | — |
| Example 12 | | | | | | | | | | | | |
| Experimental | good | good | good | poor | good | 2.74 | poor | 68.8 | 6.40 | good | poor | — |
| Example 13 | | | | | | | | | | | | |
| Experimental | good | poor | poor | good | poor | 5.63 | good | 22.1 | 5.30 | good | good | 5.54 |
| Example 14 | | | | | | | | | | | | |
| Experimental | good | good | good | good | good | 3.88 | good | 57.6 | 5.50 | good | good | 3.98 |
| Example 2 | | | | | | | | | | | | |
| Experimental | good | good | good | good | good | 3.73 | good | 57.9 | 5.74 | good | good | 3.68 |
| Example 3 | | | | | | | | | | | | |
| Experimental | good | good | good | good | good | 3.92 | good | 57.3 | 5.52 | good | good | 3.91 |
| Example 4 | | | | | | | | | | | | |
| Experimental | good | good | good | good | good | 3.99 | good | 57.2 | 5.51 | good | good | 3.93 |
| Example 6 | | | | | | | | | | | | |
| Experimental | good | good | good | good | good | 3.92 | good | 58.0 | 5.40 | good | good | 3.87 |
| Example 7 | | | | | | | | | | | | |
| Experimental | good | good | good | good | good | 3.75 | good | 51.0 | 5.55 | good | good | 3.73 |
| Example 15 | | | | | | | | | | | | |
| Experimental | good | good | good | good | good | 3.70 | good | 54.0 | 5.72 | good | good | 3.67 |
| Example 16 | | | | | | | | | | | | |
| Experimental | good | good | good | good | good | 3.10 | good | 57.0 | 6.25 | good | good | 3.06 |
| Example 17 | | | | | | | | | | | | |
| Experimental | good | good | good | good | good | 3.53 | good | 69.3 | 5.80 | good | good | 3.50 |
| Example 18 | | | | | | | | | | | | |
| Experimental | good | good | good | good | good | 3.70 | good | 69.2 | 5.80 | good | good | 3.65 |
| Example 19 | | | | | | | | | | | | |
| Experimental | good | good | good | good | good | 3.03 | good | 57.0 | 6.30 | good | good | 3.01 |
| Example 20 | | | | | | | | | | | | |
| Experimental | good | good | good | good | good | 3.40 | good | 57.1 | 5.96 [symbol] | good | good | 3.35 |
| Example 23 | | | | | | | | | | | | |

[symbol]

indicates data missing or illegible when filed

The copolymers of Reference Examples 1 to 7 were not included in the embodiments of the composition of the present disclosure. By forming the copolymers of Reference Examples 1 to 7, films and tubes can be obtained. Further, the copolymers of Reference Examples 1 to 7 can also be used for coating electric wires. As core wires of the electric wires to be coated, solid wires, stranded wires and the like can be used, and any conductors such as copper wire and silver-plated wire can be used.

### (Film Formation)

A film was prepared by using a ϕ14-mm extruder (manufactured by Imoto Machinery Co. Ltd.) and a T die. The extrusion conditions were as follows.
a) Take-up speed: 1 m/min
b) Roll temperature: 120° C.
c) Film width: 70 mm
d) Thickness: 0.10 mm
e) Extrusion condition:

$$Cylinder screw diameter = 14 mm , a single - screw extruder of L / D = 20$$

Set temperature of the extruder: barrel section C-1 (330° C.), barrel section C-2 (350° C.), barrel section C-3 (365° C.), T die section (370° C.)

It was visually confirmed that the film was prepared without any problem. The results are shown in Table 5.

### (Tube Formation)

A tube of 10.0 mm in outer diameter and 1.0 mm in wall thickness was extrusion formed by a 30-mmϕ extruder (manufactured by Tanabe Plastics Machinery Co. Ltd.). The extrusion conditions were as follows.
a) Die inner diameter: 25 mm
b) Mandrel outer diameter: 13 mm
c) Sizing die inner diameter: 10.5 mm
d) Take-over speed: 0.4 m/min
e) Outer diameter: 10.0 mm
f) Wall thickness: 1.0 mm
g) Extrusion condition:

$$Cylinder screw diameter = 30 mm , a single - screw extruder of L / D = 22$$

Set temperature of the extruder: barrel section C-1 (350° C.), barrel section C-2 (370° C.), barrel section C-3 (380° C.), head section H-1 (390° C.), die section D-1 (390° C.), die section D-2 (390° C.)

It was visually confirmed that the tube was prepared without any problem. The results are shown in Table 5.

TABLE 5

| | Film | Tube |
|---|---|---|
| | formation | formation |
| Experimental | good | — |
| Example 16 | | |
| Reference | good | good |
| Example 1 | | |
| Reference | good | good |
| Example 2 | | |
| Reference | good | good |
| Example 3 | | |
| Reference | good | good |
| Example 4 | | |
| Reference | good | good |
| Example 5 | | |
| Reference | good | good |
| Example 6 | | |
| Reference | good | — |
| Example 7 | | |

1. A composition, comprising: a polytetrafluoroethylene; and a fluorine-containing copolymer,
wherein a content of the polytetrafluoroethylene in the composition is 0.03 to 0.30% by mass with respect to a mass of the composition;
the fluorine-containing copolymer comprises tetrafluoroethylene unit, hexafluoropropylene unit and perfluoro(propyl vinyl ether) unit;
a content of hexafluoropropylene unit in the fluorine-containing copolymer is 8.5 to 11.2% by mass with respect to the whole of the monomer units;
a content of perfluoro(propyl vinyl ether) unit in the fluorine-containing copolymer is 0.5 to 2.0% by mass with respect to the whole of the monomer units; and
a melt flow rate at 372° C. of the fluorine-containing copolymer is 13.0 to 42.0 g/10 min.

2. The composition according to claim 1, wherein the content of hexafluoropropylene unit in the fluorine-containing copolymer is 9.4 to 11.0% by mass with respect to the whole of the monomer units.

3. The composition according to claim 1, wherein the content of perfluoro(propyl vinyl ether) unit in the fluorine-containing copolymer is 0.7 to 1.8% by mass with respect to the whole of the monomer units.

4. The composition according to claim 1, wherein the melt flow rate at 372° C. of the fluorine-containing copolymer is 15.0 to 38.0 g/10 min.

5. The composition according to claim 1, wherein a standard specific gravity of the polytetrafluoroethylene is 2.15 to 2.25.

6. The composition according to claim 1, wherein the content of the polytetrafluoroethylene in the composition is 0.05 to 0.20% by mass with respect to the mass of the composition.

7. An injection molded article comprising the composition according to claim 1.

8. A powder coating material comprising the composition according to claim 1.

9. A coated electric wire comprising a coating layer comprising the composition according to claim 1.
